(19) United States
(12) Patent Application Publication
(10) Pub. No.: US 2007/0259016 A1
(43) Pub. Date: Nov. 8, 2007

(54) Method of treating crops with submicron chlorothalonil

(76) Inventors: Robert L. Hodge, Sumter, SC (US); Michael P. Pompeo, Sumter, SC (US); H. Wayne Richardson, Sumter, SC (US)

Correspondence Address: MORGAN LEWIS & BOCKIUS LLP, 1111 PENNSYLVANIA AVENUE NW, WASHINGTON, DC, 20004, US

(21) Appl. No.: 11/432,408

(22) Filed: May 12, 2006

Related U.S. Application Data
(60) Provisional application No. 60/797,667, filed on May 5, 2006.

(51) Int. Cl. A01N 37/44; A01N 25/00

(52) U.S. Cl. 424/405; 514/563

(57) ABSTRACT

A chlorothalonil slurry product having greater than 90% by weight of the chlorothalonil present in discrete particles having a diameter less than 1 micron, more preferably less than 0.3 microns, is useful at reduced application rates, compared to prior art chlorothalonil formulations, to control a variety of diseases such as sapstain on wood, neck rot on onions, late blight on potatos, and downey mildew on fruits and vegetables.

### CROSS-REFERENCE TO RELATED APPLICATIONS

This application claims priority to co-pending U.S. Provisional Patent Application No. filed May 5, 2006, titled METHOD OF TREATING CROPS WITH SUBMICRON CHLOROTHALONIL, to U.S. application Ser. No. 10/961,155 titled: MILLED SUBMICRON CHLOROTHALONIL WITH NARROW PARTICLE SIZE DISTRIBUTION, AND USES THEREOF, filed on Oct. 8, 2004 and to U.S. Provisional Application titled: MILLED SUBMICRON CHLOROTHALONIL WITH NARROW PARTICLE SIZE DISTRIBUTION, AND USES THEREOF, filed on Oct. 8, 2004. The disclosures of each of these applications are incorporated herein in their entirety for all legal purposes.

### STATEMENT REGARDING FEDERALLY SPONSORED RESEARCH OR DEVELOPMENT

not applicable

### INCORPORATION-BY-REFERENCE OF MATERIAL SUBMITTED ON A COMPACT DISC

not applicable

### SEQUENCE LISTING

not applicable

### FIELD OF THE INVENTION

The present invention relates to a method of producing submicron-sized chlorothalonil particles, methods of packaging same, and uses thereof. More particularly, the invention relates to use of high density milling media having a diameter between 0.2 and 0.7 mm to provide unexpected particle size reduction and narrow particle size distribution of a chlorothalonil, and the use of this slurry in a variety of applications providing surprising and advantageous results. This milled chlorothalonil media is therefore effective at reduced application rates for a variety of surface applications, especially for treating agricultural crops, ornamentals, and other vegetation including seeds, and for treating the surface of newly milled wood as an anti-sapstain agent, an for use in paints, mold-resistant rinses, and other surface agents.

### BACKGROUND OF THE INVENTION

Chlorothalonil has very low solubility in water. The efficient distribution and use of organic pesticides is often restricted by their inherent poor water-solubility. Generally, water-insoluble organic pesticides can be applied to a site or substrate in three ways: 1) as a slurry, 2) as a solution in an organic solvent or a combination of water and one or more organic solvents and surfactants, or 3) as an emulsion that is prepared by dissolving the product in an organic solvent, then dispersing the solution in water. All of these approaches have drawbacks. Application of an active agent as a slurry is associated with drift, poses a particular health hazard related to inhaled particles, and can be limited in the available sizes to which a product can be commercially formed. Solutions and emulsions that require an organic solvent and/or surfactant are undesirable, since the solvent and surfactants comprise the large majority (both in mass and in cost of materials) of the resultant product but serves no other purpose but to act as a carrier for the product. Solvent not only adds an unnecessary cost to the formulation but also is an added health risk. Finally, emulsions are generally unstable and must be prepared at point of use, typically in the hours or minutes before use, and minor changes in the formulation, for example by addition of another biocide, may cause the emulsion to break and separate.

For environmentally stable low solubility fungicides, one simplistic model suggests the amount of a fungicide needed to protect against various pests is dependent on the number of particles in a unit area and on the particle size distribution. So long as the particle of effective fungicide exists on a surface, it will prevent or reduce disease for a very limited area of the surface on which the particle sits. If 100 particles are needed on a leaf, nearly the same efficacy is observed whether the particles are 0.3 microns in diameter as if the particles are 1.5 microns in diameter. However, the amount of fungicide needed for effective treatment, in terms of pounds per acre, can be 100 times greater for the 1.5 micron product as for the 0.3 micron product. Smaller particles can significantly reduce cost, pesticide residue on harvested crops, and mitigation of environmental impact.

It is known to mill certain organic pesticides. For instance, published U.S. Patent Application No. 2001/0051175 A1 describes milling large classes of fungicides with grinding media of substantially spheroidal shaped particles having an average size of less than 3 mm, and teaches that “suitable media material include[s] ZrO stabilized with magnesia, zirconium silicate, glass, stainless steel, polymeric beads, alumina, and titania, although the nature of the material is not believed to be critical.” The Examples used ⅛″ steel balls as grinding media, which was indeed able to reduce the mean particle size of some organic pesticides below 1 micron. We believe these inventors were incorrect in their assumption that the grinding material and size were of little importance. Further, steel balls are not particularly useful as they will undergo extreme wear and will add undesirable iron contamination to the slurry.

This is not to say that all biocides, even all low solubility fungicides, benefit from smaller size. For example, the ubiquitous elemental sulfur is generally advantageously 3 to 5 microns in diameter when used in foliar applications. While smaller particles can be readily formed, the actions of the atmosphere, moisture, and sunlight combine to eliminate the efficacy of sub-micron sulfur particles in too short a time to be of commercial interest. Additionally, particle size reduction below certain values (where said value depends very strongly on the product characteristics) can only be achieved through expensive and elaborate procedures, and such procedures quickly price the product out of the market.

Chlorothalonil is commercially available as a suspension having an average particle size diameter between about 2 and about 5 microns. It is known to mill chlorothalonil, but no milling process had ever achieved a reduction in the dso (the volume average diameter) below about 2 microns. Backman et al. found that, within the limits tested, the efficacy of Chlorothalonil tended to increase with decreasing particle size and with increasing milling. Beckman tested standard air milled chlorothalonil with wet-milled chlorothalonil. The particle sizes tested are represented below, where the air milled product is the control (a commercial product), and the hours of wet milling are provided, where “med. μ” is the median diameter in microns. The “med. μ” value is NOT the same as the d₅₀- the median particle size (“med. μ”) and the volume average particles size d₅₀ are only tangentially related and for any particle size distribution the volume average particles size will always be much higher than the median particle size. The term “<1μ, %” is the percentage of particles with a diameter less than 1 micron, and Def(0.42) is the defoliation of Florunner peanuts treated with the amount in parentheses, e.g., 0.42, in kg chlorothalonil per ha, where defoliation was presumed due top leafspot infestation:

| Mill | Mill | | | Def | Def | Def | Def |
|---|---|---|---|---|---|---|---|
| Type | Time | med. μ | <1μ, % | (0) | (0.42) | (0.84) | (1.26) |

1974 data

| | | | | | | | |
|---|---|---|---|---|---|---|---|
| Air | — | 3.3 | 7% | — | 39 | 25 | 19 |
| Wet | 3 hr | 3.8 | 8% | — | 33 | 24 | 15.5 |
| Wet | 9 hr | 1.75 | 22% | — | 32 | 17.2 | 14.1 |
| Wet | 13 hr | 1.6 | 24% | — | 27 | 23 | 15.4 |

1975 data

| | | | | | | | |
|---|---|---|---|---|---|---|---|
| Air | — | 3.3 | 5% | 39 | 35 | 34 | 27 |
| Wet | 3 hr | 3.7 | 10% | 39 | 35 | 28 | 28 |
| Wet | >9 hr | 1.6 | 22% | 37 | 32 | 29 | 29 |

It can be seen that wet milling of chlorothalonil was heretofore an extremely ineffective procedure. Generally, three hours of wet milling is very expensive and is a reasonable limit on the amount of treatment that any commercially viable product can undergo. Milling times over 9 hours are prohibitively expensive. This is not a particularly important point, however, as it is generally known (and the 13 hour milling data in Beckman show) that extended milling times over 9 hours have essentially no further effect on the particle size distribution. In the data shown above, in each case the wet milling of chlorothalonil for three hours resulted in a product having a median particle size greater than that for the commercially used air milling process. On the other hand, the number of particles having a diameter below one micron was slightly greater after wet milling for three hours compared to the air-milled control. Milling for 9 hours reduced the median particle size by about half, to about 1.6-1.8 microns, and more than doubled the number of particles having a diameter below one micron. The field test data was inconclusive. At the lowest treatment rate, the efficacy of the treatment increased with the number of particles having a diameter less than 1 micron, but this phenomenon was not true at the two higher treatment rates. See Backman, P. A., Munger, G. D., and Marks, A. F., The Effects of Particle Size and Distribution on Performance of the Fungicide Chlorothalonil, Phytopathology, Vol. 66, pages 1242-1245 (1976).

Recently there has been a changeover to higher speed, more energy intensive milling which can give results such as achieved by Beckman in a shorter period of time. U.S. Pat. No. 5,360,783, the disclosure of which is incorporated herein by reference, particularly noting the milling method and the dispersants and stabilizers disclosed therein. Chlorothalonil (Daconil) was wet milled with 2 mm glass beads (in what is presumably a high speed mill), and the resulting average particle size diameter (same as the “med. μ” value in Beckman) was 2.3 microns.

U.S. Pat. No. 5,667,795, the disclosure of which is incorporated herein be reference, particularly relating to the adjuvants, describes milling 40% chlorothalonil, 5.6% zinc oxide, 6% PLURONIC P-104 (a poly (oxypropylene) block copolymer with poly (oxyethylene), commercially available from BASF), 0.25% xanthan gum (commercially available from Kelco), 0.25% Antifoam FG-10 (silicon emulsion, commercially available from Dow Corning), 1% HI-SIL 233 (precipitated amorphous silica, commercially available from PPG Ind.), 0.4% PVP K-30 (poly(vinyl pyrrolidone), commercially available from BASF), 3% propylene glycol, 0.1% PROXEL GXL (1,2-benzisothiazolin-3-one, commercially available from ICI); 1.5% EDTA, and balance water in a high speed wet mill. This patent does not describe the milling media, but states the average particle size of the product was in the range of less than 3 microns. This appears to be representative of the average of a number of tests of commercial products that the Applicants have conducted over the last two years.

The prior art milling process can be carried to the extreme, though the resulting product will not be commercially feasible. Various mechanisms to increase milling efficacy are higher speed, intercooling (as milling is more effective at low temperature but milling at high speed will greatly increase the temperature of the milled material), by having very high loading (>60% by volume) of milling material, by using ceramic milling material (required for extended milling times at high speed), by multiple recirculations of the milled material through the milling process, and by adding high loadings of surfactants and dispersants. Curry et al. at International Specialty Products disclosed a number of experiments of “extreme milling” of a few organic biocides, where each of these parameters was maximized. For instance, U.S. Published Patent Application Nos. 2004/0063847 A1 and 2003/0040569 A1 describe milling metaldehyde with a variety of surfactants and dispersants, milling at 0-5° C. with 0.1 cm zirconia at 70% to 80% loading, and recycling the material at 19 passes per minute for 10 minutes. Fine suspensions were produced with particle size distributions in which 90% of the particles had a diameter less than 2.5 microns, and in which the mean volume diameter was less than 1.5 microns. A chlorothalonil suspension was described as being milled in the same manner, but data on particle size was not reported. However, the particle size for this experiment was disclosed in subsequently published Patent Application No. 2004/0024099 A1 (also assigned to International Specialty Products) where a composition of 41% chlorothalonil and a variety of surfactants and dispersants was wet milled under the same conditions described above, i.e., a 70% to 80% loading of 0.1 cm zirconium (sp?) beads at 3000 rpm for 10 minutes with 19 recycles per minute. The milling temperature jacket was 0° C., and the milled material was 15-21° C. The publication claims that 90% of the number of particles had a size below 0.5 microns, meaning the average particle size diameter (the “med. μ” value in Beckman) was less than 0.5 microns. However, the publication made reference to the extreme difficulty in milling chlorothalonil by the admission that the mean volume diameter (d₅₀) for this material was “less than 3 microns.” The art uses the term “less than” to denote the maximum mean diameter in a series of tests, but it is well known in the art that routine changes in parameters such as milling time will not appreciably change the mean volume diameter, as discussed infra. The resulting chlorothalonil material made according to the International Specialty Products process thus has a mean volume diameter d₅₀ of 2 to 3 microns. This is consistent with the other disclosures.

It can not be overemphasized that the benefits of small particle sizes can only be effectively realized if the particle size distribution is sufficiently narrow. For reasons not entirely clear, when milling hard-to-mill-organic biocides such as chlorothalonil to a point where there is a number of particles below one micron in diameter, a resulting wide particle size distribution is almost universally present, and the wide particle size distribution severely limits the benefits of the low particle size product, e.g., when used in paints, surface treatments, wood preservatives, agricultural treatments, and foliar applications. In Beckman, milling for over nine hours gave a product where about a fifth of the product had a diameter below one micron, but MORE THAN ONE HALF of the particles had a particle size greater than 1.6 microns. This means MUCH MORE than half (we can guess-estimate maybe 80%) of the total mass of the chlorothalonil product of Beckman had a diameter greater than 1.6 microns. This effect was even more pronounced in the exterme grinding examples provided by the International Specialty Products inventors, where their chlorothalonil composition had 90% of particles below 0.5 microns, but those meager 10% of the particles having a diameter greater than 0.5 microns weighed so much that the mean volume diameter (which we call the d₅₀, where half the weight of the product has a diameter less than the d₅₀ and about half the weight of the product has a diameter greater than the d₅₀) was in the range of 2-3 microns.

Further, it is generally known in the wet milling art that hyper-extended grinding times using milling media routinely used in the art 1) will not provide a more uniform product having a significantly narrower particle size distribution, and 2) will not significantly lower the d₅₀. It is known that compounds can be reduced to a particular particle size distribution in a relatively short amount of time, and then further milling with that media has virtually no effect. U.S. Published Patent Application No. 2004/0050298 A1, in the unrelated art of formulating pigments, discloses that wet milling in a pearl mill with mixed zirconium oxide balls having a diameter of from 0.1 to 0.3 mm could provide a desired product in 20 to 200 minutes, but that longer milling periods had no significant effect on the properties of the product, and that “as a result, the risk of overmilling can be excluded, with very great advantage for the meeting of specifications.” In co-pending co-assigned published application 10/868,967 filed Jun. 17, 2004 we described an example where we wet milled Champ DP® copper salt material (having an initial d₅₀ of 0.2 microns and an initial d₉₅ of just over a micron) for two days using 2 mm zirconia beads as the media, and particle size distribution of the resultant composition was essentially unchanged. In that application we described a new and surprising discovery, that milling crystalline or semicrystalline material such as copper salts with smaller milling media (having high density) that the resulting product will have attrition of those few particles over one micron in diameter. In co-pending and co-assigned published application Ser. No. 10/961,155 filed on Oct. 12, 2004 we disclosed that it was possible to mill chlorothalonil to micron or submicron size range where the particle size distribution was narrowed.

### SUMMARY OF THE INVENTION

The invention in a first aspect is the method of manufacture of a concentrated chlorothalonil slurry:
wherein the concentration of the chlorothalonil is between 4% and 96% by weight, typically greater than 10%, preferably greater than 20%, and most preferably greater than 30%, for example greater than 40% by weight chlorothalonil, where the upper limit on the concentration is typically less than 80%, more typically less than 70%, for example less than 60% chlorothalonil, where the balance of the product is one or more of the following components typically found in such a product, including for example water, surfactants and dispersants, dyes, particle rainfastness enhancers, antifreeze, fillers, chelators, buffers, co-biocides, and the like; and
wherein the chlorothalonil is present as solid particles which in their aggregate form a particle size distribution, and the particle size distribution is such that:
   the d₉₅ of the chlorothalonil is particles is less than 2 microns, preferably less than I micron, more preferably between 0.2 and 0.7 microns, for example between 0.3 and 0.5 microns;
   the d₅₀ is below 1 micron, preferably below 0.7 microns, more preferably below 0.4 microns, for example between about 0.1 microns and about 0.3 microns, such as between 0.13 microns and about 0.2 microns; and
   advantageously the d10 is above 0.02 microns, preferably above 0.04 microns, for example between about 0.05 microns and 0.1 microns.

One of the key aspects of the present invention is not just attaining smaller particles but also rendering the particles fairly uniform, as defined by having the narrow particle size distribution described above. We have surprisingly found that this material of this invention can be obtained by milling a traditional multi-micron starting product with sub-millimeter zirconium-based (preferably zirconium oxide-based) milling media. The most preferred milling material is a zirconium-containing metal oxide or ceramic material with a density greater than 4.5 g/cc and a size range less than 0.8 mm, preferably less than 0.5 millimeters, for example milling with a 0.1 to 0.7 mm, preferably with a 0.2 to 0.3 millimeter metal oxide or ceramic type milling material such as zirconia or modified (4.6 g/cc density) zirconia-based product. The most preferred milling material is a 0.2 to 0.3 millimeter zirconia or modified (4.6 g/cc density) zirconia-based product.

Prior art chlorothalonil formulations where the average particle size d₅₀ is above 2 microns are generally available in any concentration up to 100%, as such formulations are readily filterable and dewatered. On the other hand, prior art highly milled formulations having a significant number of submicron particles (say greater than 50% or greater than 80% of the number of particles) are very hard to circulate through a mill unless the concentration is of chlorothalonil is less than 50%, and is usually 40% or less. Further, these products are difficult to filter and dewater. The large amount of water in prior art highly milled chlorothalonil is highly detrimental, as manufacturing equipment must be oversized to handle the volume, and as the excess water results in higher packaging costs, higher transportation costs, and finally greater amounts of product must be used to obtain a desired active ingredient concentration. We have advantageously found that by milling with submillimeter zirconium-based material to a very small particle size (e.g., the d₅₀ is less than 0.2 microns, such as 0.13 to 0.17 microns) with a very narrow particle size distribution (where the d₉₅ and d₂₀ and preferably even the d₉₉ and d₁₀ are each within a factor of three of the d₅₀) we could provides a pump-able, mill-able, handle-able highly milled product at above 50% and generally to about 60% active material. The most preferred compositions of this invention have between 50% and 65% by weight chlorothalonil, more preferably between 55% and 60% by weight chlorothalonil, and therefore require less storage space, less manufacturing equipment capacity, and lower freight costs attributable to inerts such as water when compared to prior art highly milled slurries. Furthermore, the very small particle size (e.g., the d₅₀ is less than 0.2 microns, such as 0.13 to 0.17 microns) with a very narrow particle size distribution (where the d₉₅ and d₂₀ and preferably even the d₉₉ and d₁₀ are each within a factor of three of the d₅₀) allows a suspendable formulation to include only about I part by weight total of surfactants and dispersants per 8 parts chlorothalonil, while prior art formulations required about 1 part by weight total of surfactants and dispersants per about 6 parts chlorothalonil. Therefore, significant cost savings with these adjuvants can be achieved.

Another aspect of this invention is injecting a slurry comprising the chlorothalonil product such as described above into wood to act as a wood preservative agent. A number of people have recently proposed injecting slurries of organic biocides into wood, but not one party has enabled (demonstrated) a capacity to inject solid phase chlorothalonil into wood. The above-described slurry (when properly diluted to known strengths for wood treatment are not only readily injectable into wood, but can be injected so that the chlorothalonil concentration is about the same for the center of treated wood blocks as for the exterior of wood blocks. Typically, we believe the chlorothalonil concentration in wood treated southern pine sapwood with a preferred chlorothalonil slurry such as is described in Example 3 (where the d₁₀₀ was around 0.8 microns, the d₉₉ was between 0.4 and 0.5 microns, the d₉₈ was between 0.35 and 0.4 microns, the d₉₅ was between 0.2 and 0.3 microns, the d₅₀ was between 0.13 and 0.17 microns, the d₁₀ was between 0.06 and 0.08 microns, and the d₉₈ and the d₁₀ are each within a factor of three of the d₅₀, and was in fact about 3 times the d₅₀) in the 50% of the wood volume most removed from an exterior wall of the treated wood will contain at least half, and preferably at least two thirds, and most preferably at least three fourths of the chlorothalonil concentration (in pounds per cubic foot) as wood in the 50% of volume closest to an exposed surface of the wood. This is an improvement over the other embodiments of this invention, and is of particular importance because chlorothalonil being hard to mill has a strong tendency to at least partially plate out on the surface of such wood and said chlorothalonil can cause undesirable reactions when the wood is handled by workers. Chlorothalonil has a significant vapor pressure, and use of such small particles also allows a good portion of potentially irritating surface chlorothalonil to vaporize away from the surface of the wood during the drying and storing of the wood.

A preferred slurry for agricultural and horticultural use comprises the following:

| Ingredient | % by wt. | pref % by wt |
|---|---|---|
| Chlorothalonil, 99.0% | 40-65 | 52-60 |
| Surfactant | 2-10 | 3-5 |
| Dispersant | 1-6 | 1.5-3 |
| Anti Freeze | 0-8 | 0-5 |
| Anti-microbial | 0-0.5 | 0.02-0.2 |
| Anti-foam | 0-1 | 0.01-0.1 |
| Water | balance | balance |

A preferred slurry for injection into wood comprises the following:

| Ingredient | Function | % by wt. |
|---|---|---|
| Chlorothalonil, 99.0% | Active ing. | 57.6 |
| Pluronic P-104 | Surfactant | 4.22 |
| Tersperse 2425 | Dispersant | 2.11 |
| Drewplus L-768 | Anti-foam | 0.010 |
| Water | Diluent | balance |

Another principal aspect of this invention is spraying a slurry comprising the chlorothalonil product such as described above onto the surface of freshly cut and/or wet wood as a moldicide, and particularly as an antisapstain agent. Laks and others described tests of chlorothalonil on sapstain in 1991, including evaluations of emulsions and of slurries. Laks mentioned that wettable chlorothalonil powders had previously been reported to be effective against molds but to be totally ineffective against sapstain. Laks reported that micromilled flowable powder at 0.2% active ingredient and at 1% active ingredient gave 75% control. However, emulsified chlorothalonil gave 90% control at 0.5% and at 0.6% active ingredient and 85% control when using the emulsion concentrate at 0.3% active ingredients. Laks therefore did not favor the use of chlorothalonil slurries. However, chlorothalonil is primarily limited by the number of particles per unit area and the persistence of those particles. For this use, the extremely small particles such as are obtained with preferred variants of the invention (where the dloo was around 0.8 microns, the d₉₉ was between 0.4 and 0.5 microns, the d₉₈ was between 0.35 and 0.4 microns, the d₉₅ was between 0.2 and 0.3 microns, the d₅₀ was between 0.13 and 0.17 microns, the d₁₀ was between 0.06 and 0.08 microns, and the d₉₈ and the d₁₀ are each within a factor of three of the d₅₀, and was in fact about 3 times the d₅₀) are preferred and are expected ton give results equal to that seen for the emulsion concentrate, but without the instability and solvent toxicity problems associated with emulsions. Effective control should be obtained with as little as 0. 1% active ingredient sprayed on the surface of the wood until the surface is completely wetted. Much of the treated wood containing the anti-sapstain treatment may be removed in subsequent milling processes, and further chlorothalonil-treated wood is not recommended for indoor use, so it is preferred that the amount of chlorothalonil be at an absolute minimum needed to control sapstain and that residual chlorothalonil on the surface will be removed by drying and milling processes. These goals are best met by the preferred slurry of this invention having a d₅₀ between 0.13 and 0.17 microns and a d₉₀ of about 0.2 microns.

Another aspect of this invention is spraying a slurry comprising the chlorothalonil product such as described above onto the surface of crops, ornamentals, seeds, or other plants to prevent or inhibit the onset of diseases for which chlorothalonil is known, wherein the amount of material sprayed is in an amount less than 80%, preferably less than 75%, more preferably less than 50% of the dosage of traditional 2 micron slurries of chlorothalonmil while providing disease control equal to that observed when using the higher concentrations of the traditional 2 micron slurries of chlorothalonil for a period of at least 4 weeks, for example for a period of at least 6 weeks. This lowered dosage is extremely important. Many crops and ornamentals exhibit phytotoxicity to chlorothalonil, so that chlorothalonil in its traditional form can not be recommended. In greatly reduced concentrations and in the presence of the dispersants and surfactants described here, phytotoxicity is expected to be significantly reduced.

A preferred slurry for agricultural and horticultural use comprises the following:

| Ingredient | % by wt. | pref % by wt |
|---|---|---|
| Chlorothalonil, 99.0% | 40-65 | 52-60 |
| Surfactant | 2-10 | 3-5 |
| Dispersant | 1-6 | 1.5-4 |
| Anti Freeze | 0-8 | 3-5 |
| Viscosity modifier | 0-0.5 | 0.05-0.1 |
| Polymer | 0-0.5 | 0.05-0.2 |
| Anti-microbial | 0-0.5 | 0.02-0.2 |
| Anti-foam | 0-1 | 0.1-0.4 |
| Water | balance | balance |

A preferred slurry for agricultural and horticultural use comprises the following:

| Ingredient | Function | % by wt. |
|---|---|---|
| Chlorothalonil, 99.0% | Active ing. | 57.6 |
| Pluronic P-104 | Surfactant | 4.0 |
| Tersperse 2425 | Dispersant | 2.0 |
| Propylene glycol | Anti Freeze | 4.0 |
| Rhodopol 23 | Viscosity modifier | 0.05-0.1 |
| Agrimer 30 | Polymer | 0.1 |
| AMA 480 | Anti-microbial | 0.05 |
| Drewplus L-768 | Anti-foam | 0.2 |
| Water | Diluent | balance |

Another principal aspect of this invention is providing a chlorothalonil product such as described above as a wood preservative agent.

Generally, a useful chlorothalonil slurry has a d₅₀ is below 1 micron, preferably below 0.7 microns, and for certain applications, below 0.4 microns, for example between about 0.1 microns and about 0.3 microns. For foliar applications, another principal aspect of this invention is providing a method of producing a each of the above products where the d₉₀ is less than about 4 times the d₅₀, preferably less than three times the d₅₀; where the d₁₀ is advantageously greater than about ¼th the d₅₀, preferably greater than about ⅓rd the d₅₀. For wood preservation applications, another principal aspect of this invention is providing a method of producing a each of the above products where the d₉₈ , preferably the d_{99.5} is less than about 4 times the d₅₀, preferably less three times the d₅₀.

A first aspect of the invention is a method of preparing a submicron organic biocide product comprising the steps of: 1) providing the solid organic biocide and a liquid to a mill, and 2) milling the material with a milling media comprising a zirconium substance having a diameter between about 0.1 mm and about 0.7 mm for a time sufficient to obtain a product having a mean volume particle diameter of about 1 micron or smaller. A second aspect of the invention is a method of preparing a solid organic biocide product comprising the steps of: 1) providing the solid organic biocide to a mill, and 2) milling the material with a milling media, wherein at least 25% by weight of the milling media has a density greater than 3.8 and a diameter between 0.1 and 0.7 mm.

A third aspect of the invention is a method of preparing a submicron organic biocide product comprising the steps of: 1) providing the solid organic biocide and a liquid to a mill, and 2) milling the material with a milling media comprising a zirconium oxide having a diameter between about 0.1 mm and about 0.7 mm. The zirconium oxide can comprise any stabilizers and/or dopants known in the art, including, for example, cerium, yttrium, and magnesium.

A fourth aspect of the invention is a method of preparing a submicron chlorothalonil product comprising the steps of: 1) providing the solid organic biocide and a liquid to a mill, and 2) milling the material with a milling media comprising a zirconium silicate having a diameter between about 0.1 mm and about 0.7 mm and a density greater than about 5.5 grams per cubic centimeter.

A fifth aspect of the invention is a method of preparing a submicron chlorothalonil product comprising the steps of: 1) providing the chlorothalonil to a mill, and 2) milling the material with a milling media comprising a zirconium oxide having a diameter between about 0.1 mm and about 0.7 mm. The invention also encompasses a chlorothalonil product having a d₅₀ below about 1 micron, preferably below about 0.5 microns, which advantageously also exhibits a d₉₀ that is less than about three times the d₅₀, preferably less than about two times the d₅₀.

A sixth aspect of the invention is a method of preparing a submicron chlorothalonil product for use as an injectable particulate wood preservative, comprising the steps of: 1) providing the organic biocide to a mill, and 2) milling the material with a milling media having a density greater than about 3.5 and having a diameter between about 0.1 mm and about 0.7 mm. The invention also encompasses injecting the composition, which may be admixed with one or more injectable particulate sparingly soluble biocidal salts.

A seventh aspect of the invention is a method of preparing a submicron chlorothalonil product for use as a foliar treatment, or as an additive in paints or coatings, comprising the steps of: 1) providing the organic biocide to a mill, and 2) milling the material with a milling media having a density greater than about 3.5 and having a diameter between about 0.1 mm and about 0.7 mm. The density of the milling media, and especially of the milling media within the size range 0.3 to 0.7 mm, is advantageously greater than about 3.8, for example greater than about 4, preferably greater than about 5.5, for example equal to or greater than about 6 grams per cubic centimeter. Ceramic milling media is preferred over metallic milling media.

The invention also encompasses a milled chlorothalonil product from any of the above aspects and having a d₅₀ below about 0.5 microns, and in many cases below about 0.3 microns, and which further may advantageously have a d₉₀ that is less than about three times the d₅₀, preferably less than about two times the d₅₀. The invention also encompasses a organic biocide product from any of the above aspects and having a d₅₀ below about 1 micron, preferably below about 0.5 microns, for example below about 0.3 microns, which further has a d₉₅ that is less than about 1.4 microns, preferably less than about 1 micron, for example less than about 0.7 microns. In each embodiment, the milling load is preferably about 50% of the volume of the mill, though loadings between 40% and 80% are efficient. In each embodiment, advantageously water and surface active agents are added to the product before or during milling. In each embodiment, the product can be transported as a stable slurry, as a wettable powder, or as granules that disintegrate on mixing with water to release the product.

In each embodiment, the milled particulate organic biocide may be combined with another milled inorganic particulate biocide, which may be a sparingly soluble biocidal salt such as copper hydroxide, zinc hydroxide, and/or basic copper carbonate, which may be a substantially insoluble biocidal oxide, such as Copper(I) oxide and/or zinc oxide, or any combinations thereof, wherein the other particulate biocide advantageously also has a d₅₀ below about 1 micron, advantageously below about 0.5 microns. Alternatively, the second biocide may be a organometallic compound, or another organic biocide.

The literature is full of inventions where two or more biocides have a synergistic effect. Often, this is the result of the second biocide protecting the first biocide against organisms that can degrade the first biocide. The application of biocides as slurries is useful because potentially undersirable interactions between the active ingredents and/or the adjuvants of the various biocides is avoided if the biocides are in particulate form. For sparingly soluble or substantially insoluble biocides, such synergy can only be achieved if both biocides are in the area to be protected. As a result, assuming relatively equal amounts of biocide, the two sparingly soluble or insoluble biocides should be relatively comparable in size to achieve the distribution needed for effective synergy.

In some instances the second biocide is present in or as an organic liquid. In such cases, the organic liquid can be solubilized in solvent, emulsified in water, and then added to the first biocide before or during milling, or less preferably after milling. The surface of the first biocide can be made compatible with the organic phase of the emulsion, and the liquid or solvated biocide can coat the primary particles. Advantageously, solvent can be withdrawn, for example by venting the gases above the biocidal composition or by drawing a vacuum. The liquid biocide will subsequently be bound to the surface of the particulate biocide. Not only does this have the advantage of providing the two biocides in close contact so synergy will be observed, but also this provides a method for broadcasting the liquid emulsion without exposing field personnel (if the composition is for foliar applications), painters (if the composition is for non-fouling paints or coatings), and wood preservation personnel from exposure to potentially harmful solvents. Advantageously, the particulate biocidal composition, be it slurry, wettable powder, or granules, can be substantially free of volatile solvents.

Another aspect of this invention is the use of submicron clorothalonil slurries in non-fouling and in mildew resistant paint. It has previously been found that chlorothalonil is useful in paint in the form of larger particles. However, for fine paints, smaller particles are desireable. In U.S. Pat. No. 9,923,894 it is disclosed that submicron particles can be formed by polymerizing a polymer in the presence of biocide so that the biocide is incorporated into the polymer. While many examples of biocides are described generally as being useful, and while many specific examples of biocides are described as being useful, chlorothalonil is not mentioned in this patent. This patent does implicitly recognize, however, that fine paint requires use of fine particles of biocide to provide the desired biocidal effect. The amount of biocide in the particles of U.S. Pat. No. 9,923,894 is less than can be eincorporated into a solid phase particles of the present invention, however. Further, chlorothalonil has in certain instances found to be an irritant when incorporated into paint. The present invention allows encapsulating solid core particles of chlorothalonil in a particle covered by a non-volatile coating (polymeric or other organic coating) which can reduce the exposure of chlorothalonil via the paint surface, reducing this risk while still maintaining the small particles useful in fine paints.,

Another aspect of tyhis invention is the incorporation of chlorothalonil microparticles of this invention into plastics, typically during the extrusion process, to provide biocidal propertied (especially anti-mold properties) to the plastic. In such a case the particles should be dried prior to being admixed with the extruded or otherwise mixed polymeric material. The very small size of the particles of this invention allow easy incorporation into plastic, and also do not result in an undesirable roughness as the chlorothalonil is dissipated over time.

The present invention also encompasses methods of using the products of the above described processes, which include: injecting the particulate product of any of the processes described herein into wood if the composition is a wood preservative; spreading the particulate product of any of the processes described herein over crops, if the composition is used as a foliar biocide; or mixing the particulate product of any of the processes described herein into a paint or coating formulation to impart biocidal properties to the paint or coating.

One aspect of the invention is a method of manufacture of a chlorothalonil slurry comprising wet milling a chlorothalonil slurry with sub-millimeter zirconium-based ceramic or metal oxide milling media to provide a chlorothalonil product having between 4% and 96% by weight of chlorothalonil, wherein the chlorothalonil is present as solid particles which in their aggregate have a particle size distribution, and the particle size distribution is such that the d₉₅ of the chlorothalonil particles is less than 1 micron and the d₅₀ is below 0.7 microns, wherein the term d## is the diameter at wherein ## percent by weight of chlorothalonil in the product have a particle diameter less than or equal to the d##, where ## is any number greater than 0 and less than 100. Advantageously the chlorothalonil product comprises greater than 50% by weight chlorothalonil, such as between 50% and 65% by weight chlorothalonil, and the chlorothalonil product further comprises water and at least one of surfactants and dispersants. Advantageously the milling material is a zirconium-containing metal oxide or ceramic material with a density greater than 4.5 g/cc and a size range between 0.1 to 0.7 mm, such as a zirconium-containing metal oxide or ceramic material with a density greater than 4.5 g/cc and a size range between 0.2 to 0.3 mm. Such a process will economically produce a slurry concentrate wherein the d₅₀ is between about 0.1 microns and about 0.3 microns and where the d₉₅ and d₂₀ are each within a factor of three of the d₅₀. A preferred product is one where the d₅₀ is less than 0.2 microns and where the d₉₅ and d₂₀ are each within a factor of three of the d₅₀, and wherein the product comprises only about I part or less by weight total of surfactants and dispersants per 8 parts chlorothalonil. Preferred product formulations comprise about 40% to about 65% by weight of technical Chlorothalonil, between about 2% and about 10% by weight of surfactant, and between about 1% and about 6% of dispersant. More preferred product formulations comprise about 52% to about 60% by weight of technical Chlorothalonil, between about 3% and about 5% by weight of surfactant, and between about 1.5% and about 3% of dispersant. A chlorothalonil slurry product having greater than 90% by weight of the chlorothalonil present in discrete particles having a diameter less than 1 micron, more preferably less than 0.3 microns, is useful at reduced application rates, compared to prior art chlorothalonil formulations, to control a variety of diseases such as sapstain on wood, neck rot on onions, late blight on potatos, and downey mildew on fruits and vegetables. The product can be used in a method of controlling sapstain on wood comprising spraying a diluted slurry comprising the product of claim 1 on wood until the wood surface is wetted, wherein the d₅₀ is less than 0.2 microns and where the d₉₅ and d₂₀ are each within a factor of three of the d₅₀. Small particles are preferred for treatment of sapstain, so advantageously the d₉₅ is between about 0.2 and about 0.3 microns, the d₅₀ is between about 0.13 and about 0.17 microns, the d₁₀ iss between about 0.06 and about 0.08 microns, and the concentration of the diluted slurry is about o.1% to about 0.5%, preferably about 0. 1% chlorothalonil. The product of this method can also be used in a method of controlling disease on plants, including on crops, comprising spraying a diluted slurry comprising the product onto said plants. The product of this invention is particularly useful when the disease is Botrytis aclada and the crop is onion. The product of this invention is also particularly useful when the disease is late blight and the crop is potato. In such a case, and especially if the d50 of the product is between about 0.1 microns and about 0.3 microns, disease control can be obtained by application of between about 187 and about 375 g chlorothalonil per ha, or alternatively from about 24 and about 750 g per ha. The product of this invention is also particularly useful when the disease is Downey Mildew and the crop is fruit or vegetables, particularly if the application rate is between about 340 and 500 grams chlorothalonil per acre.

### DETAILED DESCRIPTION OF THE PREFERRED EMBODIMENTS

Unless otherwise specified, all compositions are given in percent, where the percent is the percent by weight based on the total weight of the entire component, e.g., of the particle, or to the injectable composition. In the event a composition is defined in “parts” of various components, this is parts by weight, such that the total number of parts in the composition is between 90 and 1 10.

As used herein, the terms “biocide” and “pesticide” are used interchangeably to mean a chemical agent capable of destroying living organisms, both microscopic and macroscopic, and not merely “pests.”

One aspect of this invention is a method of making small particles of organic biocide. Although U.S. Published Patent Application No. 2001/0051175 A1 teaches that the nature of the material is not believed to be critical, it has surprisingly been discovered that grinding media containing zirconium atoms are particularly preferable in milling methods according to the invention. In addition, while not wishing to be bound by theory, it is hypothesized that using grinding media having a sub-millimeter average particle size is necessary to achieve the desired sub-micron particle size for many difficult-to-grind biocides, e.g., chlorothalonil. The particles can be milled/ground at any suitable processing temperature where the agricultural product is stable. Typically, processing temperatures are not greater than the boiling point of water and not greater than the melting point of the solid, but ambient temperature or only slight heating or cooling is preferred. In several preferred embodiments, particularly those where the organic biocide is chlorothalonil, the volume mean particle diameter is less than about 1 micron, more preferably less than about 400 nm, and most preferably less than about 300 nm.

Particle size as used herein is the mean weight average particle diameter, which is equivalent to the mean volume average particle diameter, also known as d₅₀. For larger particles this “average” value can be determined from settling velocity in a fluid, which is a preferred method of measuring particle size. Unless otherwise specified, as used herein the biocide particle diameter is given as the d₅₀ mean volume average diameter. The dₓₓ is the diameter where the subscript “xx” is the percent of the volume of the solid material that has an average diameter smaller than the stated diameter. Other key parameters, such as d₈₀, d₉₅, and d₉₉, are similarly defined and are useful for various applications where not only is the mean volume particle diameter important but also the amount of larger particles (the size distribution, especially in the higher particle diameter range). Particle diameter can be beneficially determined by Stokes Law settling velocities of particles in a fluid, for example with a Model LA 700 or a CAPA™ 700 sold by Horiba and Co. Ltd., or a Sedigraph™ 5100T manufactured by Micromeritics, Inc., which uses x-ray detection and bases calculations of size on Stoke's Law, to a size down to about 0.2 microns. Smaller sizes are beneficially determined by for example a dynamic light scattering method, preferably with a Coulter™ counter, or a Microtrac particle size analyzer, or electron microscopy.

The preferred organic biocides for use with this invention include those organic biocides that are substantially insoluble, or are only sparingly soluble, in water, and also which are substantially stable against weathering. The reason is that the smaller particles of this invention must be sufficiently bioactive and must last a commercially acceptable time. For sparingly soluble organic biocides, enhanced bioactivity may be obtained due to the greater allowable coverage (number of particles) and tenacity associated with smaller particles, as opposed to larger particles of the same organic biocide. Enhanced bioactivity is a significant factor, as it allows the use of less biocide in an application.

By substantially insoluble, we mean the organic biocide has a solubility in water of less than about 0.1%, and most preferably less than about 0.01%, for example in an amount of between about 0.005 ppm and about 1000 ppm, alternatively between about 0.1 ppm and about 100 ppm or between about 0.01 ppm and about 200 ppm. It should be understood that the water solubilities of many pesticides are pH-dependent, as a result of the functional groups they contain. Thus, biocides with carboxylic acid groups or with sulfonamide or sulfonylurea groups, for example, may meet the low solubility requirements at low pH but may be too highly soluble at higher pH values. The pH of the aqueous dispersion can be adjusted to ensure substantial insolubility, or at least sparing solubility, of these biocides.

The organic biocide beneficially has a half life in water from about pH 3 to about pH 11 of at least about 2 days, preferably at least about one week. The organic biocide beneficially is resistant to photolysis by sunlight. By “resistant to photolysis,” we mean that particles having an average diameter of about 0.3 to about 0.5 microns will maintain at least 50% of their activity, measured against the target organism, after exposure to about 12 hours per day of sunlight at about 75% humidity and ambient temperature for 14 days. Finally, the organic biocide should be substantially non-volatile at ambient conditions, by which we mean that weight of the particles used in the above described test for photolysis should, at the end of the test, be within about 20% of the weight of the particles before the test began.

While it is not related to the performance of the particulate product, the preferred organic biocides are crystalline or semi-crystalline and have a melting temperature in excess of 100° C. Such properties tend to simplify the milling process.

Generally, the processes of this invention produce slurries or suspensions of particulate biocidal material where the particle size distribution, in various embodiments, has the following characteristics: A) a volume mean diameter, d₅₀, of less than about 1 micron and a d₉₀ of less than about 2 microns; B) a volume mean diameter, d₅₀, of less than about 0.6 micron and a d₉₀ of less than about 1.4 microns, preferably less than about 1 micron; C) a volume mean diameter, d₅₀, of less than about 0.4 micron and a d₉₀ of less than about 1 micron, preferably less than about 0.7 microns; and/or D) a volume mean diameter, d₅₀, between about 0.1 and 0.3 microns and d₉₀ that is less than about 3 times the d₅₀. The preferred processes can provide a tighter control on particle size, e.g., a particulate organic biocide composition having a d₅₀ less than about 1 micron, preferably less than about 0.5 microns, having a d₉₀ less than about twice the d₅₀, and optionally having a d₁₀ greater than about one half the d₅₀. Even more preferably, the preferred processes can provide a particulate organic biocide composition having a d₅₀ less than 1 micron, preferably less than 0.5 microns, having a d₉₅ less than about twice the d₅₀, and optionally having a d₅ greater than about one half the d₅₀.

Such tight particle size distributions is beneficial in all applications and can be as important as, if not more important than, the mean particle size. The examples in U.S. Published Patent Application No. 2004/0063847 A1 shows why this is so. For sparingly soluble and essentially insoluble biocides, protection depends on having a particle of the biocide within a particular area or volume of the substrate to be protected. The longevity of any particle, the rainfastness of any particle, and the suspendability of any particle are all functions of the particle diameter.

The U.S. Published Patent Application No. 2004/0063847 describe a chlorothalonil suspension having a distribution such that 90% of the particles have a diameter less than 0.5 microns and having a d₅₀ of “less than 3 microns” (meaning between 2 and 3 microns). Hypothetically, this chlorothalonil suspension can have 95 particles with 0.4 microns particle diameter for every 5 particles with 2.4 microns particle diameter. The mass of each of the larger particles is larger than the mass of all 95 of the smaller particles combined, and the 5 larger particles constitute about 91% of the total biocide in the formulation. The bigger particles do not protect a significantly larger area of for example a leaf than does the smaller particles. In such a scenario, if a leaf requires 100 biocide particles, it will, on average, get 95 small particles and 5 large particles of biocide. The amount of biocide, for example in pounds per acre, needed to obtain the 100 particles is over 12 times the amount that would be required if all 100 particles were smaller particles. Also, such a composition could not be injected into wood, as the large particles would plug the surface of the wood and make unsightly stains, and the homogeneity of the penetration would be compromised. In addition, such a composition would make an unsightly coating of paint, as the large particles of biocide would disrupt the thinner coating of pigment. Further, for foliar applications, the larger particles are much more susceptible to being washed from the surface than are smaller particles, so in a short time as much as 91% of the biocide mass may be useless for its application.

If, on the other hand, the d₉₀ is within a factor of two of the d₅₀ and the d₅₀ is, for example, 0.4 microns, then the situation changes radically. Such a composition may be simplified to a composition having 95 particles of 0.4 microns diameter, and about two particles with diameter of 0.8 microns. In this case, the larger particles will have rainfastness closer to the smaller particles, the larger particles would be injectable into wood, and less than 10-20% of the mass of the biocide will be in the larger particles. For these many reasons, having a narrow particle size distribution is desirable.

While generally not necessary, the particle size distribution of the product of this invention can be further narrowed, for example, by sedimentation or by filtering or centrifuging the suspension at a speed such that substantially all particles less than a certain size are removed. While a fraction of the particles may be lost to the recycling process by such a refinement, this may be preferable if the desired particle size distribution can not otherwise be achieved.

Many biocides can not be reduced to particle size d₅₀ less than about 1 micron and d₉₀ less than about 2 times d₅₀ when grinding with conventional media, e.g, 1 mm zirconia, 2 mm steel balls, and the like, at commercially acceptable milling speeds. These biocides will particularly benefit from the process of this invention, as the material and procedures described here will allow commercial production and use of products having biocide particulates with a size distribution d₅₀ less than about 0.7 microns and d₉₀ less than about 2 times d₅₀. Such biocides are known generally in the art.

Biocides include herbicides, insecticides, and fungicides. Examples of classes of compounds that have insecticidal activity and meet the solubility (and optionally also the crystallinity and melting point) requirements include, but are not restricted to, benzoyl ureas such as hexaflumuron, diacylhydrazines such as tebufenozide, carbamates such as carbofuran, pyrethroids such as alpha-cypermethrin, organophosphates such as phosmet, triazoles, and natural products such as spinosyns.

Examples of classes of compounds that have herbicidal activity and meet the solubility (and optionally also the crystallinity and melting point) requirements include, but are not restricted to, imidazolinones such as imazaquin, sulfonylureas such as chlorimuron-ethyl, triazolopyrimidine sulfonamides such as flumetsulam, aryloxyphenoxy propionates such as quizalofop ethyl, aryl ureas such as isoproturon and chlorotoluron, triazines such as atrazine and simazine, aryl carboxylic acids such as picloram, aryloxy alkanoic acids such as MCPA, chloroacetanilides such as metazachlor, dintroanilines such as oryzalin, pyrazoles such as pyrazolynate, and diphenyl ethers such as bifenox.

Examples of classes of compounds that have fungicidal activity and meet the solubility (and optionally also the crystallinity and melting point) requirements include, but are not restricted to, morpholines such as dimethomorph, phenylamides such as benalaxyl, azoles such as hexaconazole, strobilurins such as azoxystrobin, phthalonitriles such as chlorothalonil, and phenoxyquinolines such as quinoxyfen. A preferred class of materials for use in this process include the class of biocidal phthalimides, of which chlorothalonil is a prime example.

Additionally or alternately, other acceptable biocides can include, but are not limited to, diuron, chlorotoluron, simazine, atrazine, carbendazime, maneb, mancozeb, fentin hydroxide, endosulfan, and combinations thereof.

Additionally or alternately, other acceptable biocides can include, but are not limited to, amitraz, azinphos-ethyl, azinphos-methyl, benzoximate, fenobucarb, gamma-HCH, methidathion, deltamethrin, dicofol, dioxabenzafos, dioxacarb, dinobuton, endosulfan, bifenthrin, binapacryl, bioresmethrin, chlorpyrifos, chlorpyrifos-methyl, EPNethiofencarb, cyanophos, cyfluthrin, tetradifon, cypermethrin, tralomethrin, bromophos, N-2,3-dihydro-3-methyl-1,3-thiazol-2-ylidene-xylidene, 2,4-parathion methyl, bromopropylate, butacarboxim, butoxycarboxin, chlordimeform, phosalone, chlorobenzilate, phosfolan, chloropropylate, phosmet, chlorophoxim, promecarb, fenamiphos, quinalphos, resmethrin, temephos, pirimiphos-ethyl, tetramethrin, pirimiphos-methyl, xylylcarb, profenofos, acrinathrin, propaphos, allethrin, propargite, benfuracarb, propetamphos, bioallethrin, pyrachlofos, bioallethrin S, tefluthrin, bioresmethrin, terbufos, buprofezin, tetrachlorinphos, chlorfenvinphos, tralomethrin, chlorflurazuron, triazophos, chlormephos, pyrachlofos, tefluthrin, terbufos, tetrachlorinphos, cycloprothrin, betacyfluthrin, cyhalothrin, cambda-cyhalothrin, tralomethrin, alpha-cypermethrin, triazophos, beta-cypermethrin, cyphenothrin, demeton-S-methyl, dichlorvos, disulfoton, edifenphos, empenthrin, esfenvalerate, ethoprophos, etofenprox, etrimphos, fenazaquin, fenitrothion, fenthiocarb, fenpropathrin, fenthion, fenvalerate, flucythrinate, flufenoxuron, tau-fluvalinate, formothion, hexaflumuron, hydroprene, isofenphos, isoprocarb, isoxathion, malathion, mephospholan, methoprene, methoxychlor, mevinphos, permethrin, phenothrin, phenthoate, benalaxyl, biteranol, bupirimate, cyproconazole, carboxin, tetraconazole, dodemorph, difenoconazole, dodine ,dimethomoph, fenarimol ,diniconazole, ditalimfos, ethoxyquin, myclobutanil, etridiazole, nuarimol, fenpropidin, oxycarboxin, fluchloralin, penconazole, flusilazole, prochloraz, imibenconazole, tolclofos-methyl, myclobutanil, triadimefon, propiconazole, triadimenol, pyrifenox, azaconazole, tebuconazole, epoxyconazole, tridemorph, fenpropimorph, triflumizole, 2,4-D esters, diclofop-methyldiethatyl, 2,4-DB esters, dimethachlor, acetochlor, dinitramine, aclonifen, ethalfluralin, alachlor, ethofumesate, anilophos, fenobucarb, benfluralin, fenoxapropethyl, benfuresate, fluazifop, bensulide, fluazifop-P, benzoylprop-ethyl, fluchloralin, bifenox, flufenoxim, bromoxynil esters, flumetralin, bromoxynil, flumetralin, butachlor, fluorodifen, butamifos, fluoroglycofen ethyl, butralin, fluoroxypyr esters, butylate, carbetamide, chlomitrofen, chlorpropham, cinmethylin, clethodim, clomazone, clopyralid esters, CMPP esters, cycloate, cycloxydim, desmedipham, dichlorprop esters, flurecol butyl, flurochloralin, haloxyfop, ethoxyethyl, haloxyfop-methyl, ioxynil esters, isopropalin, MCPA esters, mecoprop-P esters, metolachlor, monalide, napropamide, nitrofen, oxadiazon, oxyfluorfen, pendimethalin, phenisopham, phenmedipham, picloram esters, pretilachlor, profluralin, propachlor, propanil, propaquizafop, pyridate, quizalofop-P, triclopyr esters, tridiphane, trifluralin, and the like, and any combination thereof.

Chlorothalonil—The most preferred organic biocide is chlorothalonil, CAS# 1897-45-6, also known as 2,4,5,6-tetrachloro-1,3-dicyanobenzene, chlorothananil, Tetrachloroisophthalonitrile (TCIPN), and 2,4,5,6-tetrachloro-1,3-Benzenedicarbonitrile. Technical chlorothalonil is an odorless, white, crystalline solid melting at about 250° C. Chlorothalonil is commercially available in particles having diameters greater than about 2 microns. Chlorothalonil is variously used in wood preservation to a limited extent, but is also used as a turf and crop fungicide, anti-fouling pigment and mildewcide in coatings. It is substantially insoluble in water (solubility is 0.6-1.2 ppm and is slightly soluble in acetone and xylene. It has low volatility (9.2 mmHg at 170 C.). In acid and neutral aqueous preparations, it is relatively stable but has a half life of about 38 days in water at a pH of about 9. It is thermally stable and is resistant to photolysis by ultraviolet radiation. It is also nonvolatile under normal field conditions and is not corrosive. Chlorothalonil is known to be difficult to grind and products are usually supplied as particulates having diameters in the 2-4 micron range because of this. On the other hand, chlorothalonil is known to be phytotoxic to a varety of species, and the use of large particles of the biocide amplifies this problem.

The process of this invention is capable of producing a series of chlorothalonil products with a procedure that is sufficiently cost effective that the chlorothalonil can be used for foliar agricultural treatments, wood preservatives, and anti-fouling paints, inter alia. These applications are extremely cost sensitive, and the process of this invention can be performed at a cost that is a small fraction of the cost of the raw biocidal material. In various embodiments, the methods of this invention are useful to produce a dispersion of non-agglomerating or interacting particles comprising (on a fluid-free basis) more than about 20% by weight, typically more than about 50% by weight, and often more than about 80% by weight, of chlorothalonil, with the balance of the particles, if any, typically comprising surface active agents such as stabilizers and dispersants, where the particle size distribution, in various embodiments, can have the following characteristics: A) a volume mean diameter, d₅₀, of less than about 1 micron and a dgo of less than about 2 microns; B) a volume mean diameter, d₅₀, of less than about 0.6 micron and a d₉₀ of less than about 1.4 microns, preferably less than about 1 micron; C) a volume mean diameter, d₅₀, of less than about 0.4 micron and a d₉₀ of less than about 1 micron, preferably less than about 0.7 microns; and/or D) a volume mean diameter, d₅₀, between about 0.1 and 0.3 microns and d₉₀ that is less than about 3 times the d₅₀.

Other organic biocides useful for the process of this invention are those solid biocides listed in U.S. Pat. No. 5,360,783, the disclosure of which is incorporated by reference, including o,o-dimethyl-o-4-methylthio-m-tolyl-phosphorothioate (Baycid), s-4-chlorobenzyldiethylthiocarbamate (Saturn), o-sec-butylphenylmethylcarbamate (BPMC), dimethyl-4,4-(o-phenylene)bis(3-thioallophanate) (Topsin-Methyl), 4,5,6,7-tetrachlorophthalide (Rabcide), o,o-diethyl-o-(2,3-dihydro-3-oxo-2-phenylpyridazin-6-yl)-phosphorothioate (Ofunack) and manganese ethylenebis(dithiocarbamate) (Maneb), where the particle size distribution, in various embodiments, can have the following characteristics: A) a volume mean diameter, d₅₀, of less than about 1 micron and a d₉₀ of less than about 2 microns; B) a volume mean diameter, d₅₀, of less than about 0.6 micron and a d₉₀ of less than about 1.4 microns, preferably less than about 1 micron; C) a volume mean diameter, d₅₀, of less than about 0.4 micron and a d₉₀ of less than about 1 micron, preferably less than about 0.7 microns; and/or D) a volume mean diameter, d₅₀, between about 0.1 and 0.3 microns and d₉₀ that is less than about 3 times the d₅₀. Maneb, for example, is commercially available in particle sizes greater than about 1.4 microns.

Generally the processes of this invention produce slurries or suspensions of particulate biocidal material. This material may be dried into a wettable powder, often with the addition of surface active agents and/or fillers, where fillers may include dissolvable buffering agents. The compositions resulting from the processes described herein may alternatively be formulated into fast-dissolving/releasing granules or tablets comprising the submicron organic biocidal material, such that the biocide particles are quickly released to form stable suspensions when the granule contacts water. One example of a biocide composition in tablet form, which rapidly disintegrates and disperses in water, includes, e.g., about 40 parts particulate biocide, about 10 to about 40 parts salts, preferably carbonate and/or bicarbonate salts, about 1 to about 20 parts solid carboxylic acids, about 5 to about 50 parts stabilizers and/or dispersants, and up to about 20 parts starches and/or sugars. Another exemplary dissolvable biocide granule comprises: 1) about 50-75% of a first finely-divided (submicron), essentially water-insoluble biocide, such as is produced by the processes of this invention; 2) optionally about 7-15% of a second particulate biocide, which may be a biocidal inorganic salt; 3) about 2-20% of a stabilizer and/or dispersing agent; 4) about 0.01-10% of a wetting agent; 5) about 0-2% of an antifoaming agent; 6) about 0-10% of a diluent; and optionally 7) about 0-2% of a chelating agent.

Conventional mills used for particulate size reduction in a continuous mode incorporate a means for retaining milling media in the milling zone of the mill, i.e., the milling chamber, while allowing the dispersion or slurry to recirculate through the mill into a stirred holding vessel. Various techniques have been established for retaining media in these mills, including rotating gap separators, screens, sieves, centrifugally-assisted screens, and similar devices to physically restrict passage of media from the mill. Useful liquid dispersion media include water, aqueous salt solutions, ethanol, butanol, hexane, glycols, and the like. Water, particularly water having added surface active agents, is a preferred medium.

The preferred milling procedure includes wet milling, which is typically done at mill setting between about 1000 rpm and about 4000 rpm, for example between about 2000 rpm and about 3000 rpm. Faster revolutions provide shorter processing times to reach the minimum product particle size. Generally, the selection of the milling speed, including the speed in a scaled up commercial milling machine, can be readily determined by one of ordinary skill in the art without undue experimentation, given the benefit of this disclosure.

In an alternate procedure, the biocide can be double-milled, e.g., as used to mill chitosan in paragraphs [0070]-[0074] of U.S. Published Patent Application No. 2004/0176477 A1, the disclosure of which is incorporated by reference herein. In one such embodiment, for example, the milling media in the first milling step can have a diameter of about 0.5 to 1 mm, preferably 0.5 to 0.8 mm, while the milling media in the second milling step can have a diameter of about 0.1-0.4 mm, preferably about 0.3 mm.

The milling temperature of the organic biocide can be at least about 40° C. below, preferably at least about 100° C. below the glass transition temperature (or the softening temperature, if there is no glass transition temperature, or the melting temperature, if the biocide is inorganic). Preferably, the milling takes place at a process temperature of about ambient temperature to about 40° C. To maintain an ambient milling temperature, generally active cooling is required, and the cost of active cooling generally exceeds the benefit obtained.

The milling media, also called grinding media, is central to this invention. The selection of milling media is expressly not a routine optimization. The use of this media allows an average particle size and a narrow particle size distribution that had previously not been obtainable in the art.

The milling media advantageously comprises or consists essentially of a zirconium-based material. The preferred media is zirconia (density ˜6 g/cm³), which includes preferred variants such as yttria stabilized tetragonal zirconium oxide, magnesia stabilized zirconium oxide, and cerium doped zirconium oxide. For some biocides, zirconium silicate (density ˜3.8 g/cm³) is useful. However, for several biocides such as chlorothalanil, zirconium silicate will not achieve the required action needed to obtain the narrow sub-micron range of particle sizes in several preferred embodiments of this invention.

In an alternate embodiment, at least a portion of the milling media comprises or consists essentially of metallic material, e.g., steel. Steel will, however, rapidly degrade and contaminate the product.

The milling medium is a ceramic material having a density greater than about 3.5, preferably at least about 3.8, more preferably at least 4.6 g/cc, or more preferably greater than about 5.5, for example at least about 6 g/cm³.

We believe that density and particle size are the two most important parameters in the milling media. Preferably the milling media comprises or consists essentially of particles, having a size (diameter) between about 0.1 mm and about 0.8 mm, preferably between about 0.3 mm and about 0.7 mm, for example between about 0.4 mm and 0.6 mm. Also preferably, the milling media can have a density greater than about 3.8 g/cm³, preferably greater than about 5 g/cm³, more preferably greater than about 6 g/cm³.

The zirconium-based milling media useful in the present invention can comprise or consist essentially of particles having a diameter (as the term is used in the art) between about 0.1 mm and about 0.8 mm, preferably between about 0.3 mm and about 0.7 mm, for example between about 0.4 mm and 0.6 mm. The media need not be of one composition or size. Preferably at least about 10%, preferably about 25%, alternately at least about 30%, for example between about 50% and about 99%, of the media has a mean diameter of between about 0.1 mm to about 0.8 mm, preferably between about 0.3 mm and about 0.6 mm, or alternatively between about 0.3 mm and about 0.5 mm. The remaining media (not within the specified particle size) can be larger or smaller, but, in preferred embodiments, the media not within the specified size is larger than the media in the specified size, for example at least a portion of the milling media not within the preferred size range(s) has a diameter between about 1.5 and about 4 times, for example between about 1.9 and about 3 times, the diameter of the preferred media. A preferred media is 0.5 mm zirconia, or a mixture of 0.5 mm zirconia and 1-2 mm zirconia, where at least about 25% by weight of the media is 0.5 mm zirconia. The remaining media need not comprise zirconium, but advantageously will have a density greater than 3.5 g/cc.

In an alternate embodiment, the metal, e.g., steel milling media useful in the present invention can comprise or consist essentially of particles having a diameter (as the term is used in the art) between about 0.1 mm and about 0.8 mm, preferably between about 0.3 mm and about 0.7 mm, for example between about 0.4 mm and 0.6 mm. The media need not be of one composition or size. Preferably at least about 10%, preferably about 25%, alternately at least about 30%, for example between about 50% and about 99%, of the media has a mean diameter of between about 0.1 mm to about 0.8 mm, preferably between about 0.3 mm and about 0.6 mm, or alternatively between about 0.3 mm and about 0.5 mm.

Generally, the milling media within the specified size ranges of about 0.1 mm to about 0.8 mm, for example form about 0.1 mm to about 0.7 mm or from about 0.1 mm to 0.6 mm, or alternatively from about 0.3 mm to about 0.6 mm or from about 0.4 mm to about 0.5 mm, comprises or consists essentially of a zirconium-containing compound, preferably zirconia.

Advantageously, the milling media loading can be between about 40% and about 80% of the mill volume.

Advantageously, the organic biocide can be milled for a time between about 10 minutes and about 8 hours, preferably between about 10 minutes and about 240 minutes, for example between about 15 minutes and about 150 minutes. Again, the upper limit in time is significantly less important than the lower limit, as the change in particle size distribution per hour of milling becomes exceedingly small as the milling time increases.

Aqueous dispersing agents for such dispersed solids are well known to those skilled in the art and include, but are not limited to, nonionic surfactants such as ethylene oxide/propylene oxide block copolymers, polyvinyl alcohol/polyvinyl acetate copolymers, polymeric nonionic surfactants such as the acrylic graft copolymers; anionic surfactants such as polyacrylates, lignosulfonates, polystyrene sulfonates, maleic anhydride-methyl vinyl ether copolymers, naphthalene sulfonic acid formaldehyde condensates, phosphate ester surfactants such as a tristyrenated phenol ethoxylate phosphate ester, maleic anhydride-diisobutylene copolymers, anionically modified polyvinyl alcohol/polyvinylacetate copolymers, and ether sulfate surfactants derived from the corresponding alkoxylated nonionic surfactants; cationic surfactants; zwitterionic surfactants; and the like.

The milling of the organic biocides is advantageously performed in the presence of an aqueous medium containing surfactants and/or dispersants, such as those known in the art. Use of other media, including for example polar organic solvents such as alcohols, generally does not offer added advantage sufficient to outweigh the cost and associated hazards of milling with solvents. Because it is now possible to achieve a smaller particle size and a narrower particle size distribution using the present invention than was previously known in the art, the number and amount of stabilizers and/or dispersants are less critical. As used herein, the term “surface active agent” includes both singlular and plural forms and encompasses generally both stabilizers and dispersants. The surface active agent may be anionic, cationic, zwitterionic, or nonionic, or a combination thereof. Generally, higher concentrations of surface active agents present during milling result in a smaller particle size.

However, because we have surprisingly found a milling media and conditions where very small particles and a narrow particle size distribution are obtainable, we can use less/lower amounts of stabilizers and/or dispersants than would otherwise be used. For example, advantageously the total weight of surface active agents in the present invention can be less than about 1.5 times the weight of the particulate organic biocide, preferably less than about the weight of the particulate organic biocide. A stabilizing amount of the surface active agent can be used, generally not less than about 2%, and typically not more than about 60% by weight, based on the weight of the particulate organic biocide.

Examples of suitable classes of surface active agents include, but are not limited to, anionics such as alkali metal fatty acid salts, including alkali metal oleates and stearates; alkali metal lauryl sulfates; alkali metal salts of diisooctyl sulfosuccinate; alkyl aryl sulfates or sulfonates, lignosulfonates, alkali metal alkylbenzene sulfonates such as dodecylbenzene sulfonate, alkali metal soaps, oil-soluble (e.g., calcium, ammonium, etc.) salts of alkyl aryl sulfonic acids, oil soluble salts of sulfated polyglycol ethers, salts of the ethers of sulfosuccinic acid, and half esters thereof with nonionic surfactants and appropriate salts of phosphated polyglycol ethers; cationics such as long chain alkyl quaternary ammonium surfactants including cetyl trimethyl ammonium bromide, as well as fatty amines; nonionics such as ethoxylated derivatives of fatty alcohols, alkyl phenols, polyalkylene glycol ethers and condensation products of alkyl phenols, amines, fatty acids, fatty esters, mono-, di-, or triglycerides, various block copolymeric surfactants derived from alkylene oxides such as ethylene oxide/propylene oxide (e.g., PLURONIC™, which is a class of nonionic PEO-PPO co-polymer surfactant commercially available from BASF), aliphatic amines or fatty acids with ethylene oxides and/or propylene oxides such as the ethoxylated alkyl phenols or ethoxylated aryl or polyaryl phenols, carboxylic esters solubilized with a polyol or polyvinyl alcohol/polyvinyl acetate copolymers, polyvinyl alcohol, polyvinyl pyrrolidinones (including those sold under the tradenames AGRIMER™ and GANEX™), cellulose derivatives such as hydroxymethyl cellulose (including those commercially available from Dow Chemical Company as METHOCEL™), and acrylic acid graft copolymers; zwitterionics; and the like; and mixtures, reaction products, and/or copolymers thereof.

Additionally or alternatively, the surface active agent may include, but is not limited to, low molecular weight sodium lauryl sulfates, calcium dodecyl benzene sulfonates, tristyryl ethoxylated phosphoric acid or salts, methyl vinyl ether-maleic acid half-ester (at least partially neutralized), beeswax, water soluble polyacrylates with at least 10% acrylic acids/salts, or the like, or a combination thereof.

Additionally or alternatively, the surface active agent may include, but is not limited to, alkyl grafted PVP copolymers commercially available as GANEX™ and/or the AGRIMER™ AL or WP series, PVP-vinyl acetate copolymers commercially available as the AGRIMER™ VA series, lignin sulfonate commercially available as REAX 85A (e.g., with a molecular weight of about 10,000), tristyryl phenyl ethoxylated phosphoric acid/salt commercially available as SOPROPHOR™ 3D33, GEROPON™ SS 075, calcium dodecylbenzene sulfonate commercially available as NINATE™ 401 A, IGEPAL™ CO 630, other oligomeric/polymeric sulfonated surfactants such as Polyfon H (molecular weight ˜4300, sulfonation index ˜0.7, salt content ˜4%), Polyfon T (molecular weight ˜2900, sulfonation index ˜2.0, salt content ˜8.6%), Polyfon 0 (molecular weight ˜2400, sulfonation index ˜1.2, salt content ˜5%), Polyfon F (molecular weight ˜2900, sulfonation index ˜3.3, salt content ˜12.7%), Reax 88B (molecular weight ˜3100, sulfonation index ˜2.9, salt content ˜8.6%), Reax 100 M (molecular weight ˜2000, sulfonation index ˜3.4, salt content ˜6.5%), and Reax 825 E (molecular weight ˜3700, sulfonation index ˜3.4, salt content ˜5.4%), and the like.

Other notable surface active agents can include nonionic polyalkylene glycol alkyd compounds prepared by reaction of polyalkylene glycols and/or polyols with (poly)carboxylic acids or anhydrides; A-B-A block-type surfactants such as those produced from the esterification of poly(12-hydroxystearic acid) with polyalkylene glycols; high molecular weight esters of natural vegetable oils such as the alkyl esters of oleic acid and polyesters of polyfunctional alcohols; a high molecular weight (MW>2000) salt of a naphthalene sulfonic acid formaldehyde condensate, such as GALORYL™ DT 120L available from Nufarm; MORWET EFW™ available from Akzo Nobel; various Agrimer™ dispersants available from International Specialties Inc.; and a nonionic PEO-PPO-PEO triblock co-polymer surfactant commercially available as PLURONIC™ from BASF.

Other examples of commercially available surface active agents include Atlox 4991 and 4913 surfactants (Uniqema), Morwet D425 surfactant (Witco), Pluronic P1 05 surfactant (BASF), Iconol TDA-6 surfactant (BASF), Kraftsperse 25M surfactant (Westvaco), Nipol 2782 surfactant (Stepan), Soprophor FL surfactant (Rhone-Poulenc), Empicol LX 28 surfactant (Albright & Wilson), Pluronic F108 (BASF).

In one embodiment, exemplary suitable stabilizing components include polymers or oligomers having a molecular weight from about 250 to about 10⁶, preferably from about 400 to about 10⁵, more preferably from about 400 to about 10⁴, and can include, for example, homopolymers or co-polymers described in “Polymer Handbook,” 3rd Edition, edited by J. Brandrup and E. H. Immergut.

In another embodiment, exemplary suitable stabilizing components include polyolefins such as polyallene, polybutadiene, polyisoprene, poly(substituted butadienes) such as poly(2-t-butyl-1,3-butadiene), poly(2-chlorobutadiene), poly(2-chloromethyl butadiene), polyphenylacetylene, polyethylene, chlorinated polyethylene, polypropylene, polybutene, polyisobutene, polybutylene oxides, copolymers of polybutylene oxides with propylene oxide or ethylene oxide, polycyclopentylethylene, polycyclolhexyiethylene, polyacrylates including polyalkylacrylates and polyarylacrylates, polymethacrylates including polyalkylmethacrylates and polyarylmethacrylates, polydisubstituted esters such as poly(di-n-butylitaconate), poly(amylfumarate), polyvinylethers such as poly(butoxyethylene) and poly(benzyloxyethylene), poly(methyl isopropenyl ketone), polyvinyl chloride, polyvinyl acetate, polyvinyl carboxylate esters such as polyvinyl propionate, polyvinyl butyrate, polyvinyl caprylate, polyvinyl laurate, polyvinyl stearate, polyvinyl benzoate, polystyrene, poly-t-butyl styrene, poly (substituted styrene), poly(biphenyl ethylene), poly(1,3-cyclohexadiene), polycyclopentadiene, polyoxypropylene, polyoxytetramethylene, polycarbonates such as poly(oxycarbonyloxyhexamethylene), polysiloxanes, in particular, polydimethyl cyclosiloxanes and organo-soluble substituted polydimethyl siloxanes such as alkyl, alkoxy, or ester substituted polydimethylsiloxanes, liquid polysulfides, natural rubber and hvdrochlorinated rubber, ethvi-, butyl- and benzyl-celluloses, cellulose esters such as cellulose tributyrate, cellulose tricaprylate, and cellulose tristearate, natural resins such as colophony, copal, and shellac, and the like, and combinations or copolymers thereof.

In still another embodiment, exemplary suitable stabilizing components include co-polymers of styrene, alkyl styrenes, isoprene, butenes, butadiene, acrylonitrile, alkyl acrylates, alkyl methacrylates, vinyl chloride, vinylidene chloride, vinyl esters of lower carboxylic acids, and α,β-ethylenically unsaturated carboxylic acids and esters thereof, including co-polymers containing three or more different monomer species therein, as well as combinations and copolymers thereof.

In yet another embodiment, exemplary suitable stabilizing components include polystyrenes, polybutenes, for example polyisobutenes, polybutadienes, polypropylene glycol, methyl oleate, polyalkyl(meth)acrylate e.g. polyisobutylacrylate or polyoctadecylmethacrylate, polyvinylesters e.g. polyvinylstearate, polystyrene/ethyl hexylacrylate copolymer, and polyvinylchloride, polydimethyl cyclosiloxanes, organic soluble substituted polydimethyl siloxanes such as alkyl, alkoxy or ester substituted polydimethylsiloxanes, and plybutylene oxides or copolymers of polybutylene oxides with propylene and/or ethylene oxide.

In one embodiment, the surface active agent can be adsorbed onto the surface of the biocide particle, e.g., in accordance with U.S. Pat. No. 5,145,684.

Additionally, other additives may be included in the biocidal compositions according to the invention for imparting particular advantages or to elicit particular properties. These additives are generally known in the solution, emulsion, and/or slurry arts, and can include, e.g., anti-freeze agents such as glycols (for instance, ethylene and/or propylene glycol), inter alia.

The composition preferably comprises between about 0.05% and about 50% by weight of the particulate organic biocide, e.g., chlorothalonil, or a mixture of two or more particulate biocides where one particulate biocide is the organic particulate biocide and the other particulate biocide is selected from other particulate organic biocides, particulate organometallic biocides (e.g., Maneb), slightly soluble inorganic biocides (e.g., copper hydroxide), or a combination thereof.

One of the advantages of the stable aqueous dispersion of the present invention is that it provides a means to prepare one-part formulations of different biocides which are not only compatible with each other, but incompatible or unstable in each other's presence as well. For example, it may be desirable to combine a certain pesticide with a certain herbicide for a particular application but for the fact that the two biocides (in solution, for example) react with each other faster than they can be applied to the desired site. However, in a stable aqueous dispersion of particulate biocides, these different and incompatible biocides can co-exist, at least temporarily, since they are shielded from each other from reacting rapidly, so that an end user can mix the incompatible pesticides together and apply them to a site before their efficacy is significantly diminished.

The particulate organic biocide is, in many embodiments, combined with one or more other organic biocides and/or particulate sparingly soluble biocidal inorganic salts. These inorganic biocidal salts can be milled, for example, using the same procedures and importantly the same milling media described for the organic pesticides. For instance, particulate copper(I) oxide is useful and is readily milled by the processes of this invention.

Preferred inorganic copper salts include copper hydroxides; copper carbonates; basic (or “alkaline”) copper carbonates; basic copper sulfates including particularly tribasic copper sulfate; basic copper nitrates; copper oxychlorides (basic copper chlorides); copper borates; basic copper borates; copper silicate; basic copper phosphate; and mixtures thereof. The particulate copper salts can have a substantial amount of one or more of magnesium, zinc, or both, e.g., between about 6 and about 20 parts of magnesium per 100 parts of copper, for example between about 9 and about 15 parts of magnesium per 100 parts of copper, wherein these cations are either dispersed within, or constitute a separate phase within, a particulate. In preferred embodiments of the invention, at least some particulates comprise copper hydroxide, basic copper carbonate, or both.

Preferred inorganic zinc salts and compounds include the zinc complements of the aforementioned copper salts, and expressly includes zinc oxide; the synergystic use of zinc oxide and chlorothalonil for potatoes is described in U.S. Pat. No. 5,667,795, the disclosure of which is incorporated herein by reference. This patent teaches that 2-4 micron diameter chlorothalonil particles were useful with 1-4 micron diameter zinc oxide particles. However, we believe the claimed range in this publication reflected what the inventors could manufacture. In contrast, the preferred particle size range has a chlorothalonil d₅₀ less than about 1.4 microns, for example not more than about 0.9 microns or less than about 0.5 microns, alternately from about 0.1 microns to about 0.35 microns, and preferably has a d₈₀ less than about 0.5 microns, while the zinc oxide is useful with a d₅₀ less than about 1.5 microns, for example less than about 1 micron, e.g., between about 0.3 and about 0.7 microns. Other useful zinc salts include zinc hydroxide, zinc carbonate, zinc oxychloride, zinc fluoroborate, zinc borate, zinc fluoride, and mixtures thereof.

Additionally or alternately, selected finely ground crystalline iron oxides and hydroxides (excluding gel-like materials such as Goethite) can provide biocidal activity to wood and, like the copper and zinc salts described above, can be readily milled to form injectable slurries using processes of this invention, can be readily co-mingled with the particulate organic biocide, and can be injected into the wood or used in paint. Selected sparingly soluble nickel salts and finely ground nickel oxide can provide biocidal activity to wood, and like the copper and zinc salts described above, can be readily milled to injectable slurries using processes of this invention, can be readily co-mingled with the particulate organic biocide, and can be injected into wood or used in paint.

One or more liquid organic biocides can be coated onto the particulate organic biocide, or onto the inorganic particulate biocide, if available, or both. An emulsion having dispersed liquid biocides in a small amount of solvent can be added to a composition containing the to-be-milled biocide before or during milling, for example, and the solvent can be removed by evaporation or vacuum distillation to leave the non-volatile liquid organic biocide, for example a triazole such as tebuconazole, coated onto the particulates. In addition to combining synergistic combinations of biocides, this process could help more evenly distribute the liquid biocide, which is often present in very small quantities.

Foliar Feeding Applications—Generally, the size of the particles for use in foliar feeding will depend on the required duration of treatment as well as on the weathering-resistance of each biocide.

One aspect of the invention relates to stable aqueous dispersions of the organic biocide, e.g., chlorothalonil, that can be prepared by wet milling an aqueous dispersion of the biocide in the presence of grinding media and a surface active agent, for use in foliar-type agricultural treatments, for example. For foliar feedings, the composition is generally combined with water to provide a stable suspension having the desired concentration, and this stable suspension is then broadcast onto the crops, as is known in the art.

In foliar applications, a smaller size particle is generally more persistent than a larger size particle against degenerative/deactivating forces such as rain. Field tests have proven this to be true for a preferred (d50 is 0.2 microns) formulation of this invention. The preparation can be carried out in such a manner so as to produce a dispersion of non-agglomerating or non-interacting particles having a volume median diameter, d₅₀, of less than about 1 micron and a d₉₀ of less than about 2 microns. In preferred embodiments, the preparation is carried out in such a manner so as to produce a dispersion of non-agglomerating or non-interacting particles having a volume median diameter, d₅₀, of less than about 0.6 micron and a d₉₀ of less than about 1.4 microns, preferably less than about 1 micron. In other preferred embodiments, the preparation is carried out in such a manner so as to produce a dispersion of non-agglomerating or non-interacting particles having a volume median diameter, d₅₀, of less than about 0.4 micron and a d₉₀ of less than about 1 micron, preferably less than about 0.7 microns. For example, the method according to the invention may advantageously produce a slurry where d₅₀ is between about 0.1 and about 0.3 microns and where d₉₀ is less than about 3 times d₅₀.

Anti-Fouling Coating Applications—For anti-fouling paints and coatings, if there are combinations of particulate biocides, the size of the particulates should be within a factor of about 5 of the size of the remaining particulates, though it is recognized that biocides with higher solubility may require larger particles to have the desired duration of effectiveness. One aspect of the invention relates to stable aqueous dispersions of the organic biocide, e.g., chlorothalonil, that can be prepared by wet milling an aqueous dispersion containing the biocide in the presence of grinding media and a surface active agent, for use in anti-fouling paints and coatings, for example.

It is known to use 0.5 mm zirconia as a milling media for certain pigments to be used in paints. U.S. Published Patent Application No. 2003/0127023 A1 teaches that pigments having improved colouristic properties and process for their preparation, and describes examples where compositions containing pigments and additives are milled with 0.5 mm diameter zirconia milling media. In this publication, Irgaphor™ DPP Red B-CF (mean particle size about 50 nm, available from Ciba Specialty Chemicals Inc) was admixed in a vessel with 8 mg Solsperse™ S22000 (Zeneca); 32 mg Solsperse™ S24000 (Zeneca); 200 mg of a copolymer of aromatic methacrylates and methacrylic acid (MW from 30,000 to 60,000); 1.76 g of (1-methoxy-2-propyl)-acetate; and 5 g zirconia beads of diameter 0.5 mm. The vessel was sealed with an inner cup placed in an operating paint conditioner for 3 hours, in order to yield a dispersion. The milled pigments forming the ingredients in this patent were all less than 0.2 microns in average diameter before milling, and most examples contained pigments with average particle size less than 0.1 microns before milling. This illustrates the advantage of this invention. Generally, it is known that pigments in paints form a more impermeable layer if the particle size of the pigments is reduced. However, this has not been applied to the biocides—until now, there was no economical and reliable method of obtaining chlorothalonil, for example, at such a small particle size. Now, our method allows a variety of biocidal agents approved for use in anti-fouling paints and coatings to be reliably milled to provide both the desired submicron d₅₀ but also to provide the desired narrow particle size distribution, exemplified by dgo (and preferably d₉₅) being less than about twice the d₅₀.

Commonly used biocides in marine applications includes copper(I) oxide, copper thiocyanate, Cu powder, zinc oxide, chromium trioxide, Irgarol™ 1051, zinc pyrithione, dichlofluanid, TCMBT (2-(thiocyanomethylthio) benzothiazole, a liquid biocide), chlorothalonil, 2,3,5,6-tetrachloro-4-sulfuronyl pyridine, SeaNine 211 (4,5-dicholo-2-n-octyl-4- isothiazolin-3-one), ziram (zinc dimethyldithiocarbamate or bis(dimethylcarbamodithioato-S,S′)zinc), zineb, folpet, and the like. Generally, the particles are held in place by the paint or coating matrix. The sizes of the particulate biocides are therefore primarily a function of the anticipated duration of the treatment and the biocide dissolution rate, and are also a function of the desired particle size for the paint or coating. Finer particles make smoother and less permeable coatings. The copper oxide, zinc oxide, and the chlorothalonil are particularly suited for grinding into submicron-sized particles, having, e.g., d₅₀ from about 0.1 to about 0.9 microns, and, e.g., a d₉₀ less than three times, preferably less than two times, the d₅₀ value. For instance, one example would be a composition with a d₅₀ of about 0.2 microns and a d₉₀ of about 0.4 microns or less. Such small particles, when combined with adequate particle size distribution control, would provide greater coverage, less permeability, and more gloss than was previously obtainable with formulations using larger particulates having a wider size distribution.

The preparation is carried out in such a manner so as to produce a dispersion of non-agglomerating or non-interacting particles having a volume median diameter, d₅₀, of less than about 1 micron and a d₉₀ of less than about 2 microns. In preferred embodiments, the preparation is carried out in such a manner so as to produce a dispersion of non-agglomerating or non-interacting particles having a volume median diameter, d₅₀, of less than about 0.6 microns and a d₉₀ of less than about 1.4 microns, preferably less than about 1 micron. In other preferred embodiments, the preparation is carried out in such a manner so as to produce a dispersion of non-agglomerating or non-interacting particles having a volume median diameter, d₅₀, of less than about 0.4 micron and a d₉₀ of less than about 1 micron, preferably less than about 0.7 microns. For example, the method according to the invention may advantageously produce a slurry where d₅₀ is between about 0.1 and about 0.3 microns and where d₉₀ is less than about 3 times d₅₀.

Injectable Wood Preservative Applications—For wood treatments, the overriding consideration is that the particles of each biocide, and of the combined biocides, be injectable into the wood matrix.

One aspect of the invention relates to stable aqueous dispersions of the organic biocide, e.g., chlorothalonil, that can be prepared by wet milling an aqueous dispersion of the biocide in the presence of grinding media and a surface active agent, for use as an injectable wood preservative, for example. The injectable particulate organic biocide can, for example, comprise chlorothalonil, metaldehyde, manganese ethylenebis(dithiocarbamate) (Maneb), salts thereof, or mixtures thereof.

Another aspect of the invention relates to wood or a wood product comprising a milled biocide according to the invention and, optionally, one or more additional materials having a preservative function, injected into a piece of wood. The concurrent use of other organic biocides, inorganic biocidal sparingly soluble salts and/or oxides, and liquid organic biocides coated onto the particulate biocides can be particularly useful for treating wood, where combinations of biocides are commonly used.

The requirements of injectability for substantially round/spherical particles (e.g., in which the diameter is one direction is within a factor of two of the diameter measured in an orthogonal direction) include, but are not limited to, the following: where d₉₈ is not more than about 0.5 microns, preferably not more than about 0.3 microns, for example not more than about 0.2 microns; and/or where d_{99.5} is less than about 1.5 microns, preferably less than about 1 micron, for example less than about 0.7 microns. The preparation is carried out in such a manner so as to produce a dispersion of non-agglomerating or non-interacting particles that meet the above requirements, and further having a volume median diameter, d₅₀, of less than about 0.4 microns and preferably a d₉₀ of less than about 0.7 microns. Different wood materials require different particle sizes, but the above ranges are generally sufficient for Southern Pine wood.

Other aspects of the present invention include methods for preparing the ground biocide particulates according to the invention, methods of formulating injectable wood treatment compositions that comprise ground biocide particulates, methods of transporting the injectable wood treatments, methods of mixing and injecting the ground biocide particulate composition according to the invention into wood and/or wood products, and also the wood and wood products themselves treated with the ground biocide particulate compositions according to the invention.

In preferred embodiments, the preparation is carried out in such a manner so as to produce a dispersion of non-agglomerating or non-interacting particles having a volume median diameter, d₅₀, of less than about 0.35 microns and a d₉₅ of less than about 0.7 microns, preferably less than about 0.5 microns. In other preferred embodiments, the preparation is carried out in such a manner so as to produce a dispersion of non-agglomerating or non-interacting particles having a volume median diameter, d₅₀, of less than about 0.3 microns and a d₉₅ of less than about 0.6 microns, preferably less than about 0.5 microns. For example, the method according to the invention may advantageously produce a slurry where d₅₀ is between about 0.1 and about 0.3 microns and where d₉₀ is less than about 3 times d₅₀. In one preferred embodiment, at least 80% by weight of the organic biocide particulates have a size/diameter between about 0.05 microns and about 0.4 microns.

Injectability can and often does require that the particulates be substantially free of the size and morphology that will tend to accumulate and form a plug or filter cake, generally on or near the surface of the wood, that results in undesirable accumulations on wood in one or more outer portions of the wood and thus a deficiency in an inner portion of the wood. Injectability is generally a function of the wood itself, as well as the particle size, particle morphology, particle concentration, and the particle size distribution. We recognize that a competitor may spike a composition with a small number of very large particles, in a quantity where the very large particles are not injected but are also not present in an amount which can impede usefulness of the product. In these cases, having very distinct bi-modal distributions of particles where the larger particles are not injectable, it is appropriate to ignore those very large particles when calculating the particle size distributions. For example, a composition having about 90% of particles in the range of about 0.02 to about 0.5 microns will be injectable into wood, if the remaining 10% has, for example, a particle diameter of at least about 5 microns, which size is so large that pore blocking may be reduced.

The particulate organic biocides of this invention can be incorporated into wood composites, by either being mixed with binder, by coating wood fibers prior to binding, by being injected into wood chips prior to binding, or any combination of the above. Preferred wood composites have the ground biocide according to this invention (and/or a composition containing same) either mixed with the wood particles before bonding, or preferably injected into the wood particulates and dried prior to bonding.

By “injectable,” we mean the ground biocide particulates are able to be pressure-injected into wood, wood products, and the like, to depths normally required in the industry, using equipment, pressures, exposure times, and procedures that are the same or that are substantially similar to those currently used in industry. Pressure treatment is a process performed in a closed cylinder that is pressurized, forcing the chemicals into the wood. In preferred embodiments of the invention, incising is not expected to be required to inject the slurries of the present invention into lumber having thicknesses of about 6 to about 10 inches. Wood or wood products comprising ground biocide particles according to the invention may be prepared by subjecting the wood to vacuum and/or pressure in the presence of a flowable material comprising the ground biocide particles. A pre-injection of carbon dioxide followed by vacuum and then injection of a biocidal slurry is one preferred method of injecting the slurry into wood. Injection of particles into the wood or wood product from a flowable material comprising the particles may require longer pressure treatments than would be required for liquids free of such particles. Pressures of, for example, at least about 75 psi, at least about 100 psi, or at least about 150 psi may be used. Exemplary flowable materials include liquids comprising ground biocide particles, emulsions comprising ground biocide particles, and slurries comprising ground biocide particles. In one embodiment, a volume number density of the ground biocide particles according to the invention about 5 cm from the surface, and preferably throughout the interior of the wood or wood product, is at least about 50%, for example, at least about 60%, at least about 70%, or at least about 75% of the volume number density of the ground biocide particles about 1 cm from the surface.

The requirements of injectability for substantially round/spherical, rigid particles (e.g., in which the diameter is one direction is within a factor of two of the diameter measured in an orthogonal direction) generally include, inter alia: 1) that substantially all the particles, e.g., greater than about 98% by weight, have a particle size with diameter not more than about 0.5 microns, for example not more than about 0.3 microns or not more than about 0.2 microns; and 2) that substantially no particles (e.g., less than about 0.5% by weight) have a diameter greater than about 1.5 microns, or an average diameter greater than about 1 micron, for example. We believe the first criterion primarily addresses the phenomena of bridging and subsequent plugging of pore throats, and the second criterion addresses the phenomena of forming a plug, or filter cake. Once a pore throat is partially plugged, complete plugging and undesired buildup generally quickly ensues.

In one embodiment, the size distribution of the injectable particles requires that the vast majority of particles (for example at least about 95% by weight, preferably at least about 99% by weight, more preferably at least about 99.5% by weight) be of an average diameter less than about 1 micron. Advantageously, the particles are not too elongated, or rod-shaped, with a single long dimension. Average particle diameter is beneficially determined by Stokes Law settling velocities of particles in a fluid to a size down to about 0.2 microns. Smaller sizes are beneficially determined by for example a dynamic light scattering method or laser scattering method or electron microscopy. Generally, such a particle size and particle size distribution can be achieved by mechanical attrition of particles.

Attrition can be obtained by wet milling in a sand grinder charged with, for example, partially stabilized zirconia beads with a diameter of about 0.5 mm; alternatively wet milling in a rotary sand grinder with partially stabilized zirconia beads with a diameter of about 0.5 mm and with stirring at, for example, about 1000 rpm or more; or by use of a wet-ball mill, an attritor (e.g., manufactured by Mitsui Mining Ltd.), a pearl mill (e.g., manufactured by Ashizawa Ltd.), or the like. Attrition can be achieved to a lesser degree by centrifugation, but larger particles can be simply removed from the composition via centrifugation. Removing the larger particulates from a composition can provide an injectable formulation. Said particulates can be removed by centrifugation, where settling velocity substantially follows Stokes law.

The most effective method of modifying the particle size distribution is wet milling. Beneficially all injectable formulations for wood treatment should be wet-milled, even when the “mean particle size” is well within the range considered to be “injectable” into wood. Even when a few weight percent of particles exhibit a size above about 1 micron, this small amount of material is hypothesized to form the start of a plug (where smaller, normally injectable particles are subsequently caught by the plug). Further, it is believed that wet milling with larger-sized media (e.g., 2 mm zirconium silicate) will have virtually no effect, resulting in only a marginal decrease in particle size, such that the material will still not be injectable in commercial quantities.

However, it has been found that a milling process using about 0.5 mm high density zirconium-containing (e.g., preferably zirconium oxide) grinding media provides efficient attrition, especially for the removal of particles greater than about 1 micron in the commercially available biocide particulate product. The milling process usually takes on the order of minutes to achieve almost complete removal of particles greater than about 1 micron in size. As stated above, the size of the milling material is believed to be important, even critical, to obtaining a commercially acceptable process. The milling agent material having a diameter of about 2-3 mm or greater are ineffective, while milling agent material having a diameter of about 0.5 mm is effective typically after about 15 minutes of milling.

### EXAMPLES

The following examples are merely indicative of the nature of the present invention, and should not be construed as limiting the scope of the invention, nor of the appended claims, in any manner.

### Example 1

### West Milling Chlorothalonil With 0.5 mm Zirconium Silicate Milling Media

The laboratory-sized vertical mill was provided by CB Mills, Model # L-3-J. The mill has a 2 liter capacity and is jacketed for cooling. Unless otherwise specified, ambient water was cycled through the mill cooling jacket during operation. The internal dimensions are 3.9″ diameter by 9.1″ height. The mill uses a standard 3 x 3″ disk agitator (mild steel) on a stainless steel shaft, and it operates at 2,620 rpm.

The media used in this Example was 0.4-0.5 mm zirconium silicate beads supplied by CB Mills. All particle size determinations were made with a Sedigraph™ 51 0OT manufactured by Micromeritics, which uses x-ray detection and bases calculations of size on Stokes' Law.

The formulation contained 20.41% chlorothalonil (98% active), 5% Galoryl™ DT-120, 2% Morwet™ EFW, and 72.6% water by weight, and the concentrate had a pH of 8.0. The total batch weight was about 600 g. The results of a 7.5 hour grinding study are given in Table 1 below.

TABLE 1

| | | |
|---|---|---|
| | | Particle Size Data - |
| | | Volume % With |
| Milling Time | d₅₀ | Diameter Greater Than |

| Mins. | μm | 10 μm | 5 μm | 2 μm | 1 μm |
|---|---|---|---|---|---|
| 0 | 4.9 | 10 | 48 | 95 | |
| 30 | 1.3 | 0 | 4 | 21 | 68 |
| 60 | 1.0 | 4 | 2 | 11 | 50 |
| 90 | 1.4 | 18 | 23 | 22 | 94 |
| 120 | 1.03 | 2 | 0 | 4 | |
| 150 | 1.12 | 0 | 2 | 6 | 58 |
| 180 | 1.07 | 2 | 2 | 7 | 53 |
| 270 | 1.09 | 2 | 0 | 8 | 54 |
| 450 | 1.15 | 12 | 8 | 21 | 56 |

The results show that chlorothalonil can be wet milled from a starting particle size (d₅₀) of about 3-5 microns to a d₅o near 1 micron within about one hour, using a spherical ˜3.8 g/cm³ zirconium silicate media having an average particle size of about 0.4-0.5 mm. Further grinding had little effect, possibly slightly reducing the weight of particles over about 2 microns and thereby reducing the d₉₀ from about 2 microns at 60 minutes to slightly less than 2.

However, these results also showed the limitations of this lower density milling material when used on material that is known to be difficult to mill. In the next example, higher density doped zirconia, having a density of 5.5 to 6.5 g/cc, was used and provided much more effective milling.

### Example 2

### Milling Chlorothalonil With 0.5 mm Zirconium Oxide

The same mill and conditions were used in this experiment as in experiment 1. However, the grinding media was 0.4-0.6 mm cerium-doped zirconium oxide beads obtained from CB Mills. The density of the cerium doped zirconium oxide is ˜6.0 g/cm³. The formulation contained 20.41% chlorothalonil (98% Active), 5% Galoryl™ DT-120, 2% Morwet™ EFW, 3% Pluronic™F-108, and 69.6% water by weight, and the concentrate had a pH of about 7.3. The total batch weight was about 600 g. The results are shown in Table 2 below.

TABLE 2

| | | Particle Size Data - | | | | | |
|---|---|---|---|---|---|---|---|
| | | Volume % With | | | | | |
| Milling Time | d₅₀ | Diameter Greater Than | | | | | |
| Mins. | μm | 10 μm | 5 μm | 2 μm | 1 μm | 0.4 μm | 0.2 μm |
| 0 | 3.44 | 8 | 30 | 77 | 92 | — | — |
| 90 | 0.31 | 3 | 3 | 3 | 3 | 22 | — |
| 240 | 0.21 | 0 | 1 | 2 | 3 | 3 | 51 |

For the higher density 0.5 mm zirconia milling media, a composition with a d₅₀ less than 1 micron and a d₉₅ less than 1 micron was obtainable in 90 minutes, and a composition with a d₅₀ less than 0.3 microns and a d₉₅ less than 0.4 microns was obtainable in 6 hours. The product obtained after 90 minutes of milling represents an increase in number of particles per unit of mass by a factor of more than about 30 over the standard products, but the product obtained after 90 minutes of milling represents an increase in number of particles per unit of mass by a factor of more than about 1000 over the standard products. The higher surface areas associated with the smaller particles should give rise to a product with enhanced bioactivity due to an increase in reservoir activity (ability to deliver chlorothalonil to the infection court).

### Example 3

### Pilot Plant Wet Milling Chlorothalonil With 0.2-0.3 mm Zirconia Milling Media

A pilot plant-sized LMZ-10 mill (10 liter chamber) filled with 0.2-0.3mm “Zir-Star” yttria stabilized zirconia-zirconium silicate media (by St. Gobain) was used to wet mill 50 gallons of CTL slurry (57% active conc) to a median particle size d₅₀ of 0.15 microns. In this experiment the particle size was determined by the Netzsch Fine Particle Technology facility in Exton, Pa. using a Microtrac Inc particle size analyzer. We have previously shown with copper salts and with chlorothalonil that milling with zirconium silicate (density 3.8 g/cc) was useful, but that milling with zirconia (density ˜5.8 g/cc, ceria-stabilized zirconia density 6.1 g/cc, and yttria-stabilized zirconia density of about 5.95 g/cc) was much more effective at reducing particle size of difficult-to-mill material like chlorothalonil. One problem with high density media like zirconia is there is excess wear of all components including the mill itself. A intermediate density zirconia milling product having a density of 4.6 g/cc (4.5 to 5 g/cc)was selected to try to reduce the milling media and mill wear. To overcome the efficiency loss anticipated with the intermediate density product, an even smaller milling media, less than 0.4 mm, preferably 0.2 mm to 0.3 mm product was used.

The formulation contained the following:

| Ingredient | Function | % by wt. |
|---|---|---|
| Chlorothalonil, 99.0% | Active ing. | 57.6 |
| Pluronic P-104 | Surfactant | 4.22 |
| Tersperse 2425 | Dispersant | 2.11 |
| Drewplus L-768 | Anti-foam | 0.010 |
| Water | Diluent | balance |

There were a wide variety of low speed and high speed milling tests run. some data is presented below:

| | minutes milling | | | | | | | |
|---|---|---|---|---|---|---|---|---|
| | 20 | 40 | 60 | 95 | 120 | 150 | 180 | 210 |
| | low | low | low | low | medium | medium | high | high |
| Microns | speed | speed | speed | speed | speed | speed | speed | speed |
| (d10) | 0.772 | 0.662 | 0.804 | 0.688 | 0.594 | 0.507 | 0.413 | 0.360 |
| (d50) | 2.374 | 1.702 | 1.785 | 1.342 | 1.019 | 0.836 | 0.633 | 0.514 |
| (d90) | 14.53 | 3.552 | 3.224 | 2.559 | 1.913 | 1.612 | 1.183 | 0.821 |
| (d97) | 19.18 | 4.831 | 3.934 | 3.154 | 2.389 | 2.117 | 1.588 | 1.098 |
| (d99) | 27.98 | 8.033 | 5.600 | 4.308 | 3.269 | 3.153 | 2.454 | 1.769 |

The shaft speed was varied during the milling study, running at 1000 RPM for the first two hours, 1200 RPM for the next hour, 1300 RPM for the next 12 hours, and 1400 RPM for the last two plus hours, providing a tip speed of 11.6, 13.9, 15. 1, and 16.3 meters per second respectively. The milling temperature ranged from 20° to 46° C. The 50 gallons of slurry was pumped from a mixing vessel (approx 70 gal.) into the mill and back into the same mixing vessel (re-circulated continuously except for shift breaks). A final high speed milling test was done on a slurry for more than 10 hours, and he dloo was around 0.8 microns, the dg₉ was between 0.4 and 0.5 microns, the d₉₈ was between 0.35 and 0.4 microns, the d₉₅ was between 0.2 and 0.3 microns, the d₅₀ was between 0.13 and 0.17 microns, and the d₁₀ was between 0.06 and 0.08 microns. In this example the d98 was less than 4 times the d₅₀, and was in fact about 3 times the d₅₀. The d₁₀ was within a factor of 3 of the d₅₀. This is an ideal particle size distribution for a number of uses, and the particular advantages of this slurry outweigh the costs of the extended milling time.

### Example 4

### Brown Rot Fungus Control in Wood

Wood wafers tests were carried out in accordance with AWPA Standard E10. Wafers measuring 5 mm by 18 mm by 18 mm were cut from defect-free southern pine sapwood. Chlorothalonil treating solitions were prepared having concentrations of 0.1, 0.3, 0.5, 0.7, 0.9, and 1.2 percent CTN. A set of control treating solutions had the chlorothalonil dissolved in toluene, and the test solutions was an injectable sub-micron chlorothalonil particulate slurry (in water). Eight replicates were made of each test. Treated wafers were placed in plastic cups which formed the decay chambers (4 wafers to a cup) and the incubation time was 4 weeks as opposed to the often used 12 weeks. Radial compression strength was used to measure the extent of decay. The tests and the calculated toxic threshold ranges were determined under the direction of Dr. Darell D. Nicholas at the Forest Products Department of Mississippi State.

Wafers treated with the highest concentration of chlorothanonil, the 1.2% active solution, showed slight (1 to 2%) increases in the compressive strength compared to untreated products. Those wafers were not exposed to brown rot fungus. The series of wafers that were exposed to brown rot fungus did exhibit compressive strength loss. For the controls treated with chlorothalonil in toluene and for the test wafers treated with chlorothalonil slurry, the strength loss was complete when the treatment was with 0.1% chlorothalonil (retention was 0.034 to 0.038 pound per cubic foot) in either the solution or in the slurry form. For the next lowest treatment level, using a 0.3% chlorothalonil composition, treatment with the control chlorothalonil toluene solution gave a retention of 0.098 pound per cubic foot compressive strength loss was again complete (100%) . Surprisingly, treatment with the 0.3% chlorothalonil slurry of this invention gave higher retention of 0.113 pound per cubic foot AND much reduced compressive strength loss of only 44%. The retention of chlorothalonil on wafers treated with the slurries of this invention were slightly higher than the retention of chlorothalonil on wafers treated with chlorothanonil toluene solutions for each of the 0.5%, 0.7%, 0.9%, and 1.2% chlorothalonil treatment solutions. Compressive strength retention was significantly higher at each test point for wafers treated with the slurry of this invention than with slurries treated with the chlorothalonil-toluene solution. At the highest treatment strength uning 1.2% chlorothalonil, compressive strength loss was 11.3% for wafers treated with the chlorothalonil-toluene solution and only 7.7% for wafers treated with the chlorothalonil slurry. The slightly elevated treatment efficacy observed with wafers treated with the slurries of this invention might be due to the slightly higher retention of chlorothalonil on the wood compared to treatments using solubilized chlorothalonil. Slurry delivery is at least as effective as solution delivery of chlorothalonil in toluene in preventing brown rot fungus attack.

### Example 5

To test the efficacy of smaller chlorothalonil particles in a controlled environment, Dr. Howard F. Schwartz, Professor of Plant Pathology, Colorado State University, Fort Collins, Colo. performed a test sequence to test the bioactivity of chlorothalonil slurries in an agar against a known pathogen, Botrytis aclada (Botrytis Neck Rot pathogen of Onion). Use of chlorothalonil against this pathogen is well documented, and there is a specific recommended concentration “X” to treat this pathogen. The control was commercially available Chlorothalonil of about 3 micron particle diameter with what is believed to be an EO-PO block copolymer dispersant (Bravo 720™). The two experimental milled chlorothalonil biocides were Samples A and B. Sample A was milled so that the d₅₀ was 0.2 microns. Sample B was milled so that the d₉₀ was under 0.2 microns.

Milled and a control Chlorothalonil products were slurried and then were added to 1 Liter of ½ PDA (potato dextrose agar) after autoclaving and cooling, where the amount added was X, 0.667X, 0.333X, or 0.1X. The agar was then allowed to set in a circular plate, and the center 38 mm² core of the cylinder was inoculated with 14-day-old Botrytis aclada, and then the plates were incubated for 14 days at 22° C. Growth of the colony was measured each day for 6 days for statistical analysis. Growth was measured an additional 8 days to determine number of days before the colony reached the outer edge of the plate. There were 10 samples for each biocide at each rate, and results were averaged. The data relating to overall growth rate until full infestation (when the barrier is reached) is summarized in Table 3 below.

TABLE 3
Growth Rate Per Day of Botrytis Colony
after 6 days of Incubation on PDA

| | | Growth Rate | |
|---|---|---|---|
| Chlorothalonil | Concentration | (mm²/d) | Days to reach barrier |
| d₅₀ = 3μ, prior art | 1X | 220 | >14 |
| d₅₀ = 3μ, prior art | 0.67X | 295 | 10-13 |
| d₅₀ = 3μ, prior art | 0.33X | 231 | 10-13 |
| d₅₀ = 3μ, prior art | 0.1X | 416 | 10-13 |
| d₅₀ = 0.2μ | 1X | 39 | >14 |
| d₅₀ = 0.2μ | 0.67X | 117 | >14 |
| d₅₀ = 0.2μ | 0.33X | 151 | >14 |
| d₅₀ = 0.2μ | 0.1X | 236 | 10-13 |
| d₉₀ = 0.2μ | 1X | 58 | >14 |
| d₉₀ = 0.2μ | 0.67X | 41 | >14 |
| d₉₀ = 0.2μ | 0.33X | 152 | >14 |
| d₉₀ = 0.2μ | 0.1X | 287 | 10-13 |
| Control | 0 | 923 | 5 |

It can be seen that the prior art formulation at a IX dose provided reasonable biocidal activity, in that the growth rate was 23.8% of the growth rate when no biocide was added. The test methodology and cut-off date at 14 days was also seen to be validated, as the prior art formulation at a 1× dose did not reach the barrier during the 14 day test. Treatments 1 (d₅₀=3μ particles at 1 × concentration), 5-7 (d₅₀=0.2μ at 1×, 0.67×, and 0.33× concentrations), and 9-11 (d₉₀=0.2μ at 1×, 0.67×, and 0.33× concentrations) restricted fungal growth and never allowed the fungus to reach the outer edge of the plate throughout the 14-day test period. Treatments 2- 4 (d₅₀=3μ particles at 0.67×, 0.33×, and 0.1× concentration), 8 (d₅₀=0.2μ at concentration of 0.1×), and 12 (d₉₀=0.2μ at concentration of 0.1×) allowed the fungus to reach the outer edge of the plate between days 10 and 13. Total maximum growth of the control was 5539 mm². Cutting the dose rate of the prior art formulation to 0.67× and to 0.33× dose provided reduced biocidal activity when compared to the biocidal activity at 1×, as expected, but the biocidal activity of the prior art formulation was seen to drop precipitously when the dose rate was further reduced to 0.1×. At a dose rate of 0.1×, the prior art formulation exhibited a growth rate of 413 square millimeters per day, which is over 45% of the growth rate observed in the total absence of biocide.

The formulations of this invention showed remarkably increased biocidal activity against Botrytis at every dosage rate when compared to the prior art formulation. The biocidal activity at 0.33× dosage rate was much greater than the biocidal activity of the prior art formulation at 1× dosage. The biocidal activity at 0.1× dosage rate was greater than the biocidal activity of the prior art formulation at 0.67× dosage.

The daily measurements for days 1-6 are provided in Table 6. The milled submicron slurry products A and B were consistently more effective than the commercially available product, and there was a consistent response to the rate comparisons between the 3 products in this lab test.

TABLE 6
Area (mm²) of Botrytis Colony on PDA, Days 1-6,

| Treatments | | | Day 1 | | Day 2 | | Day 3 | | Day 4 | | Day 5 | | Day 6 | |
|---|---|---|---|---|---|---|---|---|---|---|---|---|---|---|
| 1 | d50 = 3μ | 1X | 46 | BC | 46 | DE | 92 | CD | 352 | CD | 755 | D | 1321 | D |
| 2 | d50 = 3μ | 0.67X | 44 | C | 44 | DE | 108 | C | 405 | C | 871 | C | 1773 | C |
| 3 | d50 = 3μ | 0.33X | 42 | C | 42 | E | 50 | E | 313 | D | 690 | D | 1384 | D |
| 4 | d50 = 3μ | 0.1X | 43 | C | 61 | B | 161 | B | 501 | B | 1093 | B | 2497 | B |
| 5 | d50 = 0.2μ | 1X | 46 | BC | 48 | DE | 89 | CD | 131 | FG | 181 | F | 235 | G |
| 6 | d50 = 0.2μ | 0.67X | 48 | ABC | 48 | DE | 48 | E | 149 | FG | 389 | E | 701 | F |
| 7 | d50 = 0.2μ | 0.33X | 43 | C | 43 | DE | 64 | DE | 218 | E | 497 | E | 906 | E |
| 8 | d50 = 0.2μ | 0.1X | 43 | C | 58 | BC | 104 | C | 310 | D | 683 | D | 1416 | D |
| 9 | d90 = 0.2μ | 1X | 46 | BC | 46 | DE | 47 | E | 100 | GH | 219 | F | 347 | G |
| 10 | d90 = 0.2μ | 0.67X | 51 | AB | 51 | CD | 51 | E | 66 | H | 151 | F | 247 | G |
| 11 | d90 = 0.2μ | 0.33X | 47 | ABC | 47 | DE | 49 | E | 178 | EF | 481 | E | 914 | E |
| 12 | d90 = 0.2μ | 0.1X | 43 | C | 51 | CD | 92 | CD | 322 | D | 747 | D | 1721 | C |
| 13 | Control | NA | 52 | A | 92 | A | 274 | A | 1317 | A | 3039 | A | 5539 | A |

| | | | | | | |
|---|---|---|---|---|---|---|
| Probability | <0.0001 | <0.0001 | <0.0001 | <0.0001 | <0.0001 | <0.0001 |
| C.V. % | 15.11 | 19.50 | 38.63 | 23.09 | 18.46 | 18.91 |
| LSD (alpha 0.01) | 5.72 | 8.39 | 30.08 | 64.07 | 114.63 | 192.01 |

The first experiment, using prior art 3 micron chlorothalonil at the recommended 1× dosage, provided the expected good control of the Botrytis. In every test, for any concentration of chlorothalonil, the milled submicron chlorothalonil slurries of this invention provided superior control of the Botrytis than did the unmilled control. What was particularly surprising was that both of the milled submicron chlorothalonil samples at both 0.67× and at 0.33× concentrations provided significantly superior control of Botrytis than did the unmilled commercial product applied at the recommended dosage 1×. This suggests that the milled product of the present invention will be effective against Botrytis at a fraction of the currently recommended application rate, for example between one third and two thirds of the application rate recommended for foliar application of prior art slurries, with no loss of effectiveness. Further, the small size of the particles coupled with the protective effects provided by dispersants, pigments, and/or dyes can mitigate phytotoxicity of the chlorothalonil, and can increase rainfastness, when compared to the prior art formulation. If necessary, use of encapsulation with dispersants can mitigate chlorothalonil degradation due to exposure to light.

### Example 6

In this test an evaluation was made of the treatment efficacy of submicron slurries of chlorothalonil on Downy Mildew. The test was performed at the Clemson University Coastal Research and Education center in Charleston, S.C. A variety of crops grown in Yonges loamy fine sand soil at ph of 6.3. By the end of the season, downey mildew had infected 11 of 14 muskmelon, 6 of 13 cucumber, and 13 of 15 watermelon plant patches, so pathogen 5 of P cubense was present. Among many tested formulations were sub-micron chlorothalonil formulations of this invention and a variety of combinations of fungicides which in most cases included applications of a prior art chlorothalonil product having a weight average particle size of 3 microns (Bravo Weather Stik™), where the prior art chlorothalonil formulation was applied at 2 pts of 720 g/L slurry per acre or 681.3 grams chlorothalonil per acre, which is twice the dose rate of 340.7 grams chlorothalonil per acre as was used for the experimental formulations. A variety of combinations of commercial treatments were tested with the prior art chlorothalonil formulation, with the expectation that the formulations of the current invention would perform as well as the prior art formulations which included either periodic or weekly applications of chlorothalonil at twice the dose used for the experimental slurries. The test proceeded with fungicide applications on August 25, September 2, September 9, September 16, September 23, and September 30. During the high mold growth periods, weekly spraying is the norm. Downy mildew was first detected on September 6, but September was a dry month so infestation severity remained low. A planned application of the chlorothalonil slurries on October 7 could not be made for reasons un-related to the test (a tropical depression and extremely heavy rains), and the report not surprisingly states “there was unfortunately a rapid increase in downy mildew between October 6 and October 13.” This missed application is believed to have had an adverse effect on the activity of the experimental slurries in excess of the effect on the activity of the prior art formulations, as the experimental slurries were applied at half the dosage of the prior art slurries and had less of a reservoir of reserve fungicide, and as chlorothalonil has a better preventative effect than curative effect while some of the combinations of fungicides included materials having a stronger curative effect.

A first control was with water. The disease severity was ranked 90%, with 24.5 fruit per plot and 18.1 pounds of fruit per plot being recovered. Fruit treated with 2 pt dosage of Bravo Weather Stik™ had a severity of 48%, with 30.1 fruit per plot and 24.6 pounds of fruit per plot being recovered. In contrast, fruit treated with one half the dosage (1 pt) of a slurry of this invention had a disease severity of 83%, though with 31.5 fruit per plot and 24.1 pounds of fruit per plot being recovered, the productivity of the plants was not significantly different between a 340.7 grams chlorothalonil per acre application of a slurry of this invention and a 681.3 grams chlorothalonil per acre application of prior art chlorothalonil. A wide variety of other treatment combinations were tried, including A) Ridomil Gold Bravo™ alternated with Amistar™; B) Bravo Weather Stik™ (at 2 pt) alternated with Ridomil Gold Bravo™ and Amistar™; C) Cabrio™ with Manzate Pro Stick™ alternated with Forum™ and Bravo Weather Stik™ (at 2 pt); D) Cabrio™ with Forum™ alternated with Manzate Pro Stick™ and Bravo Weather Stik™ (at 2 pt); E) Gavel™ alternated with Tanos™; F) Tanos™ with Manzate Pro Stick™ alternated with Previcur Flex™ and Bravo Weather Stik™ (at 2 pt); and finally G) Bravo Weather Stik™ (at 2 pt) alternated with Switch™. All fungicides were used at recommended strength as listed on the commercial fungicide label, and when combinations of fungicides were used for a treatment each fungicide was applied at its full recommended strength.

Of the many combinations, most of which included at least two 681.3 grams chlorothalonil per acre treatments of prior art chlorothalonil, only treatments D and E gave fruit production (number of fruit per plot) which exceeded that obtained with 340.7 grams chlorothalonil per acre treatments with the experimental slurry application of this invention, and then only by a few percent, while most treatments provided 10% to 15% less fruit per plot. Of the many combinations, most of which included at least two 681.3 grams chlorothalonil per acre treatments of prior art chlorothalonil, only treatments C, D and E gave plots which exceeded the fruit production (in pounds of fruit per plot) that was obtained with 340.7 grams chlorothalonil per acre treatments with the experimental slurry, with most other treatments falling 10% lower. Of the many combinations, most of which included at least two 681.3 grams chlorothalonil per acre treatments of prior art chlorothalonil, only treatments A, B E, G, and H gave plots which exhibited lower disease severity than was obtained with 340.7 grams chlorothalonil per acre treatments with the experimental slurry.

While conditions were not ideal, the half strength chlorothalonil slurry of this invention was as good as or superior to a wide variety of applications, most of which included at least some treatments with prior art chlorothalonil at twice the strength. The prior art formulation at 681.3 grams chlorothalonil per acre per treatment was slightly superior to the present formulation at 340.7 grams chlorothalonil per acre per treatment. An ideal treatment may include 340.7 grams or 500 grams chlorothalonil of this invention per acre per treatment combined with one or more of the other fungicides, as combinations of fungicides are known to be more effective. Alternatively, an ideal treatment may include 500 grams chlorothalonil of this invention per acre per treatment. Surprisingly, equal or better fruit productivity was observed with 340.7 grams chlorothalonil of this invention per acre per treatment as compared with most every other fungicide and fungicide combination, most of which included treatments with chlorothanonil slurries of the prior art at 681.3 grams chlorothalonil per acre.

### Example 7

In this test applications of a prior art formulation of chlorothalonil and of a formulation of the present invention (d50<0.2 microns) were made to the foliage of a food crop. The experimental purpose was to test product persistence on crops over time, given the typical variations in wind, rain, humidity, and other factors that affect pesticide persistence. The persistence of the present product was superior to that of the prior art formulation over the test period (about four weeks). The increased rain-fastness and wind-fastness of the experimental particles more than outweighed any increase in product degradation due to weathering phenomena expected in the reduced size.

### Example 8

This test greenhouse study (directed by SurfaPlus B) showed that application of slurries of this invention were efficacious when compared with higher dosage applications of commercial product on potatoes innoculated with phytophthera infestans (late blight). Typically, effective control of this pathogen required many treatments, which depending on locale could mean a dozen or more treatments, with one or more fungicides. The potato plants were Bintje, the most widely-grown yellow variety in the world. The plants were grown in 5 liter pots with tubers placed at 10 cm depth. The plants were inoculated with a one week old culture of P. infestans, at 10000 sporangi per milliliter, with a 50 microliter droplet being placed on each of 5 leaflets in a leaf, such that for each plant 20 leaflets were inoculated and there were 80 point inoculations per treatment. The plants, after they reached a height of 30 to 40 cm, were sprayed with the fungicidal applications in a carefully controlled spray room environment that provided 250 liters per ha to provide 1500 g chlorothalonil per ha (at 100%). After application of the fungicides, all plants were grown in a greenhouse. The dosage rate was 100% or 1500 g/ha, 50% or 750 g/ha, 25% or 375 g/ha, and 12.5% or 187 g/ha for Experiments #1, and 25% or 375 g/ha, 12.5% or 187 g/ha, 6.3% or 94 g/ha, and 3.1% or 46 g/ha for Experiment #2, and rates extended even lower in Experiment 3.

In Experiment 1, the 4 day and 8 day infestation data is provided in Table 7 below.

TABLE 7
Data from Experiment 1

| | Prior art formulation | | | Experimental formulation | | |
|---|---|---|---|---|---|---|
| Treatment | | lesion | | | lesion | |
| g/ha | % leafs (a) | size (b) | a * b | % leafs (a) | size (b) | a * b |

Four Days After Inoculation

| | | | | | | |
|---|---|---|---|---|---|---|
| 0 | 100% | 56% | 0.56 | 99% | 35% | 0.35 |
| 187 | 11.3% | 19% | 0.021 | 3.8% | 23% | 0.009 |
| 375 | 7.5% | 36% | 0.027 | 1.3% | 30% | 0.004 |
| 750 | 13.8% | 20% | 0.033 | 2.5% | 10% | 0.003 |
| 1500 | 1.3% | 50% | 0.007 | 0 | ND | 0 |

Eight Days After Inoculation

| | | | | | | |
|---|---|---|---|---|---|---|
| 0 | 99% | 34% | 0.34 | 99% | 28% | 0.28 |
| 187 | 18.8% | 17% | 0.032 | 12.5% | 10% | 0.013 |
| 375 | 25% | 24% | 0.06 | 2.5% | 15% | 0.004 |
| 750 | 5% | 15% | 0.008 | 2.5% | 17% | 0.004 |
| 1500 | 7.5% | 28% | 0.021 | 13.8% | 23% | 0.031 |

In Experiment 1, the 4 day infestation data showed the experimental formulation leaf infestation was at least two times, and typically was at least three times less than that observed using the prior art formulation. The data at 100% (1500 g/ha) was suspect, suggesting additional influences, as the infestation was higher than the 50% (750 g/ha) dosage for both the prior art formulation and for the experimental formulation. Clearly, the experimental formulation having a d50 of about 0.2 microns provided much higher degrees of protection than did the prior art formulation (having a d50 of 2-4 microns). Indeed, adequate disease control (a*b<0.02) was observed for the experimental formulation at application rates as low as 187 g chlorothalonil per ha, and excellent disease control (a*b<0.008) was observed for the experimental formulation at application rates as low as 375 g chlorothalonil per ha.

In the eight day trials, the data is consistent except for the 100% dosage treatment, which the data seems to indicate is much less effective than a treatment at half that dosage for both the prior art formulation and for the formulation of the present invention. Other than the data for that point, the disease control is clearly superior for the experimental formulation of this invention, not only when comparing equal dosage rates but also when using one half the dosage of the experimental product compared to the dosage of the prior art formulation.

Two subsequent Experiments were performed, using the same experimental conditions. In Experiment 2, the dosage rates ranged from 3.1% to 25%, but conditions were such that both treatment formulations were extremely effective, with less than 9% lesions observed in every treatment dosage for both products, and with a mixed and non-conclusive result on which formulation performed better. In Experiment 3, the range of applied doses ranged from 100% to 0.025%. In the early (4 days after innoculation) data, below 0.1% dosage rates, the fungicidal applications were ineffective. At the 0.4% and 1.6%, the formulation of the present invention was better than the prior art formulation. But, at higher concentrations, the prior art formulation was more effective. The eighth day analysis was more definitive. This data is shown in Table 8 below.

TABLE 8
Data from Experiment 3
Eight Days After Inoculation

| | Prior art formulation | | | Experimental formulation | | |
|---|---|---|---|---|---|---|
| Treatment | | lesion | | | lesion | |
| g/ha | % leafs (a) | size (b) | a * b | % leafs (a) | size (b) | a * b |
| 0 | 86% | 24% | 0.21 | 84% | 28% | 0.24 |
| 1.5 | 85% | 33% | 0.28 | 94% | 30% | 0.28 |
| 6 | 38% | 22% | 0.084 | 74% | 28% | 0.21 |
| 24 | 24% | 22% | 0.053 | 3% | 13% | 0.004 |
| 94 | 23% | 20% | 0.046 | 8% | 23% | 0.018 |
| 375 | 4% | 30% | 0.012 | 1% | 10% | 0.001 |
| 1500 | 0% | — | 0 | 3% | 20% | 0.006 |

Again, treatment at dosages of 6 g/ha were not particularly effective, though the prior art slurry appeared to be more effective than the experimental slurry. While the data is somewhat mixed, at dosages between 24 g/ha and 375 g/ha (that is, at dosages of about 24 g/ha, 94 g/ha, and 375 g/ha), the experimental application was clearly more effective at controlling disease than was the prior art formulation. ). Indeed, adequate disease control (a*b<0.02) was observed for the experimental formulation at application rates as low as 24 g chlorothalonil per ha, and excellent disease control (a*b<0.008) was observed for the experimental formulation at application rates of 375 g chlorothalonil per ha.

The invention is illustrated by the examples but is not intended to be limited to the invention. Much of the advantage of the preferred formulation of the present invention is that a slurry with a 0.2 micron d50 will have about 1000 times as many discrete fungicide particles as does the same weight of active ingredients of a formulation with a 2 micron size. As the active ingredient is active only over an extremely limited area about a particle, the presence of more particles significantly reduces the risk of unprotected areas existing on a leaf. Further, the smaller particles are more rainfast, and additives to enhance rainfastness are more effective for smaller particles than for larger particles. Further, the loss of a number of particles will have very little effect with the preferred formulation, while the loss of the same number of particles from a prior art slurry might result in complete loss of protection. These factors more than overcame the increased rate of loss of active ingredients from losses due to hydrolysis and photolysis that are expected to be larger for smaller particles than for bigger particles. We have formulated and found very useful chlorothalonil formulations with a d50 well below 0.2 microns. Further, a formulation with a d50 of 0.3 or 0.4 microns will share a portion of the benefits observed for the most preferred slurries,. Therefore, the invention is intended to be limited only by the allowed claims.

What is claimed is:

1. A method of manufacture of a chlorothalonil slurry comprising:
wet milling a chlorothalonil slurry with sub-millimeter zirconium-based ceramic or metal oxide milling media to provide a chlorothalonil product having between 4% and 96% by weight of chlorothalonil, wherein the chlorothalonil is present as solid particles which in their aggregate have a particle size distribution, and the particle size distribution is such that the d₉₅ of the chlorothalonil particles is less than 1 micron and the d₅₀ is below 0.7 microns, wherein the term d## is the diameter at wherein ## percent by weight of chlorothalonil in the product have a particle diameter less than or equal to the d##, where ## is any number greater than 0 and less than 100.

2. The method of claim 1 wherein the chlorothalonil product comprises greater than 50% by weight chlorothalonil, and the chlorothalonil product further comprises water and at least one of surfactants and dispersants.

3. The method of claim 2 wherein the chlorothalonil product comprises between 50% and 65% by weight chlorothalonil.

4. The method of claim 1 wherein the milling material is a zirconium-containing metal oxide or ceramic material with a density greater than 4.5 g/cc and a size range between 0.1 to 0.7 mm.

5. The method of claim 1 wherein the milling material is a zirconium-containing metal oxide or ceramic material with a density greater than 4.5 g/cc and a size range between 0.2 to 0.3 mm.

6. The method of claim 1 wherein the d₅₀ is between about 0.1 microns and about 0.3 microns and where the d₉₅ and d₂₀ are each within a factor of three of the d₅₀.

7. The method of claim 3 wherein the d₅₀ is between about 0.1 microns and about 0.3 microns and where the d₉₅ and d₂₀ are each within a factor of three of the d₅₀.

8. The method of claim 3 wherein the d₅₀ is less than 0.2 microns and where the d₉₅ and d₂₀ are each within a factor of three of the d₅₀, and wherein the product comprises only about 1 part or less by weight total of surfactants and dispersants per 8 parts chlorothalonil.

9. The product of the method of claim 3 wherein the product comprises about 40% to about 65% by weight of technical Chlorothalonil, between about 2% and about 10% by weight of surfactant, and between about 1% and about 6% of dispersant.

10. The product of the method of claim 3 wherein the product comprises about 52% to about 60% by weight of technical Chlorothalonil, between about 3% and about 5% by weight of surfactant, and between about 1.5% and about 3% of dispersant.

11. A method of controlling sapstain on wood comprising spraying a diluted slurry comprising the product of claim 1 on wood until the wood surface is wetted, wherein the d₅₀ is less than 0.2 microns and where the d₉₅ and d₂₀ are each within a factor of three of the d₅₀.

12. The method of claim 11 wherein the d₉₅ is between about 0.2 and about 0.3 microns, the d₅₀ is between about 0.13 and about 0.17 microns, the d₁₀ iss between about 0.06 and about 0.08 microns, and the concentration of the diluted slurry is about 0. 1% chlorothalonil.

13. A method of controlling disease on plants comprising spraying a diluted slurry comprising the product of claim 1 onto said plants.

14. The method of claim 13 wherein the disease is Botrytis aclada and the plant is onion.

15. The method of claim 13 wherein the d50 of the product is between about 0.1 microns and about 0.3 microns.

16. The method of claim 13 wherein the disease is late blight and the plant is potato.

17. The method of claim 16 wherein the d50 of the product is between about 0.1 microns and about 0.3 microns and wherein application rate is between about 187 and about 375 g per ha.

18. The method of claim 16 wherein the d50 of the product is between about 0.1 microns and about 0.3 microns and wherein application rate is between about 24 and about 750 g per ha.

19. The method of claim 13 wherein the disease is Downey Mildew and the plant is a fruit or vegetable.

20. The method of claim 19 wherein the d50 of the product is between about 0.1 microns and about 0.3 microns and wherein application rate is between about 340 and 500 grams chlorothalonil per acre.
